(19) United States
(12) Patent Application Publication
(10) Pub. No.: US 2026/0243009 A1
(43) Pub. Date: Aug. 20, 2026

(54) AUTOMATED APPLIANCES WITH WATER RECYCLING

(71) Applicant: Bryan DADDIO, Port Washington, NY (US)

(72) Inventors: Bryan DADDIO, Port Washington, NY (US); Stephen E. DELAPORTE, Devon, PA (US); Randolph Beauregard ROBERT, III, Delaware, OH (US)

(73) Assignee: Bryan DADDIO, Port Washington, NY (US)

(21) Appl. No.: 19/642,882

(22) Filed: Apr. 9, 2026

Related U.S. Application Data
(63) Continuation-in-part of application No. 18/911,764, filed on Oct. 10, 2024.
(63) Continuation-in-part of application No. PCT/US24/50677, filed on Oct. 10, 2024.
(60) Provisional application No. 63/589,225, filed on Oct. 10, 2023.
(60) Provisional application No. 63/589,225, filed on Oct. 10, 2023.

(51) Int. Cl. D06F 39/20; B01D 53/26; B01D 61/02; B01D 61/14; C02F 1/00; C02F 1/44; C02F 1/78; C02F 103/00; D06F 25/00; D06F 34/28; D06F 39/08; D06F 39/10; D06F 103/68; D06F 105/58

(52) U.S. Cl. CPC D06F 39/20; B01D 53/26; B01D 61/025; B01D 61/145; C02F 1/008; C02F 1/441; C02F 1/444; C02F 1/78; D06F 25/00; D06F 34/28; D06F 39/085; D06F 39/088; D06F 39/10; B01D 2257/80; B01D 2258/06; C02F 2103/002; C02F 2201/005; C02F 2201/782; C02F 2307/12; D06F 2103/68; D06F 2105/58

(57) ABSTRACT

One embodiment relates to an automated appliance with water recycling, comprising a washing machine, a drying unit, and a recycling unit configured to recycle grey water or used water within the machine. In addition, one embodiment relates to a compact washing machine and recycling unit that includes a dehumidifier that removes water from the air, so the water from the dehumidifier can be used in the washing machine and recycling unit cycle.

### CROSS REFERENCE TO RELATED APPLICATIONS

This application is a continuation in part application of International Application PCT/US 2024/050677 filed on Oct. 10, 2024, and a continuation in part application of U.S. patent application Ser. No. 18/911,764 filed on Oct. 10, 2024, which is a non-provisional application that hereby claims priority from provisional application Ser. No. 63/589,225 filed on Oct. 10, 2023, the disclosure of these applications are incorporated herein by reference in their entirety.

### BACKGROUND OF THE INVENTION

One embodiment of the invention relates to an automated appliance with water recycling comprising a compact washing machine, drying unit, and recycling unit. Previously, washing machines would require a standard full plumbing water feed to operate. In small apartments, such as in New York City, there is not much room for the placement of a washing machine and recycling unit in the middle of the apartment. This causes parties to have to go outside of the apartment to have their laundry cleaned. Therefore, there is a need for a standalone washing machine and recycling unit that is compact and that can fit inside a person's apartment.

### SUMMARY

One embodiment of the invention relates to a compact washing machine and/or washer dryer combination unit and recycling unit that is configured to recycle grey water or used water inside of the machine. In addition, at least one embodiment of the invention relates to a compact washing machine and recycling unit that has a dehumidifier that pulls water from the air so that the water from the dehumidifier can be used for a washing machine and recycling unit cycle.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawings are designed for the purpose of illustration only and not as a definition of the limits of the invention.

In the drawings, wherein similar reference characters denote similar elements throughout the several views:

FIG. 1 is a perspective view of a washing machine and recycling unit outer body;

FIG. 2 is a top view of the embodiment shown in FIG. 1;

FIG. 3A is a front view;

FIG. 3B is a bottom perspective view of the washing machine and recycling unit;

FIG. 4 is a perspective exploded view of the washing machine and recycling unit;

FIG. 5 is a top exploded view of the washing machine and recycling unit;

FIG. 6A is a bottom-front-right perspective view of the washing machine and recycling unit with the outer housing and wastewater or grey water bin removed;

FIG. 6B is a side view of the washing machine and recycling unit shown in FIG. 6A;

FIG. 7 is a perspective view of the washing machine and recycling unit shown in FIG. 6A:

FIG. 8 is a top view of the embodiment shown in FIG. 6A;

FIG. 9 is a perspective view of the washing machine and recycling unit with the outer cover removed with the grey water bin being present;

FIG. 10 is a perspective view of a portion of the dehumidifier;

FIG. 11A is a bottom perspective view of the O₃ generator;

FIG. 11B is a top perspective view of the O₃ generator;

FIG. 12 is a perspective view of a grey water pump;

FIG. 13 is a perspective view of the water feed pump;

FIG. 14 is a perspective view of a reverse osmosis filter;

FIG. 15 is a perspective view of a coagulant and flocculant assistant;

FIG. 16A is a perspective view of a wastewater bin with the bladder;

FIG. 16B is a perspective exploded view of the wastewater bin and the bladder;

FIG. 17 is a flow chart and schematic layout of the progression of water and/or fluids in the system;

FIG. 18 is an alternative flow chart;

FIG. 19 is an alternative flow chart;

FIG. 20 is an alternative flow chart;

FIG. 21 is an alternative flow chart;

FIG. 22 is an alternative flow chart;

FIG. 23A is an alternative flow chart;

FIG. 23B is an alternative flow chart;

FIG. 24 is an alternative flow chart;

FIG. 25 is a perspective view of one embodiment of the appliance;

FIG. 26 is a perspective view with the top loader open;

FIG. 27 is a front perspective view with the with the purge container being positioned on the side of the housing;

FIG. 28 is a top perspective view which shows the top loader door being open;

FIG. 29 is a top perspective view with the top loader door open and the drum door closed;

FIG. 30 is a view of the device with the purge tank being removed;

FIG. 31A is a front view of the device;

FIG. 31B is a side view with the housing removed;

FIG. 32A is a side view of the bottom portion in a transparent view;

FIG. 32B is another side transparent view with the purge tank being in an open position;

FIG. 33 is a back perspective view of another embodiment;

FIG. 34 is a back perspective view with the input opening being shown;

FIG. 35 is a back perspective view with the purge tank being removed;

FIG. 36A is a back perspective view of the recycling system being removed from the appliance;

FIG. 36B is a front perspective view of the recycling system removed from the appliance;

FIG. 37 is a closer front perspective view of the recycling system;

FIG. 38 is an exploded view of the appliance with the recycling system being removed;

FIG. 39 is an exploded perspective view of the recycling system;

FIG. 40 is a front perspective view of the detergent system with the detergent cartridge being removed;

FIG. 41A is a front perspective view of the detergent system with the detergent cartridge inserted into the tray;

FIG. 41B is a front perspective view of the detergent cartridge in the tray with the tray in the inserted position;

FIG. 42 is a back perspective view of the detergent system;

FIG. 43A is a top view of the control panel in a first stage;

FIG. 43B is another top view of the control panel in a second stage;

FIG. 44A is a top view of the control panel in another stage;

FIG. 44B is a top view of the control panel in another stage;

FIG. 45 is a schematic block layout of the electronic components in the system;

FIG. 46 is a schematic block layout of the network for controlling the controller shown in FIG. 45;

FIG. 47A is a view of the layout of the electronic components of the servers;

FIG. 47B is a view of the layout of the electronic components of the portable devices;

FIG. 48 is a flow chart of the process for controlling the device;

FIG. 49 is a flow chart for the cycles of the water through the system;

FIG. 50A is a first schematic block diagram of multiple appliances with a single recycling system; and

FIG. 50B is a schematic block diagram with multiple appliances each having their own recycling system;

FIG. 51 is a schematic layout of another embodiment of a combined washer/dryer system;

FIG. 52 is a schematic layout of another embodiment of a combined washer/dryer system.

FIG. 53 is a flow chart for the process for recycling water in a washing machine or other appliance;

FIG. 54 is a side view of another embodiment;

FIG. 55 is a perspective view of the embodiment of FIG. 54;

FIG. 56 is a front view of the embodiment of FIG. 54;

FIG. 57 is a perspective view of the embodiment of FIG. 54;

FIG. 58 is a top view of the embodiment of FIG. 54;

FIG. 59 is a perspective cross-sectional view of the embodiment of FIG. 54;

FIG. 60 is a back view of the embodiment of FIG. 54;

FIG. 61 is a perspective view of the embodiment of FIG. 54;

FIG. 62 is a side perspective view of the embodiment of FIG. 54;

FIG. 63 is a side view of the embodiment of FIG. 54;

FIG. 64 is an exploded view of the embodiment of FIG. 54;

FIG. 65 is a front view with the front panel removed of the embodiment of FIG. 64;

FIG. 66 is a side view of the embodiment with a side panel removed of FIG. 64;

FIG. 67 is an opposite side view of the embodiment of FIG. 64;

FIG. 68 is a back view of the embodiment of FIG. 64;

FIG. 69 is a perspective view of the embodiment of FIG. 64;

FIG. 70 is a side perspective view of the embodiment of FIG. 64;

FIG. 71 is a top-front-right side perspective view of the embodiment of FIG. 64; and

FIG. 72 is a top-back right-side view of the embodiment of FIG. 64.

### DETAILED DESCRIPTION

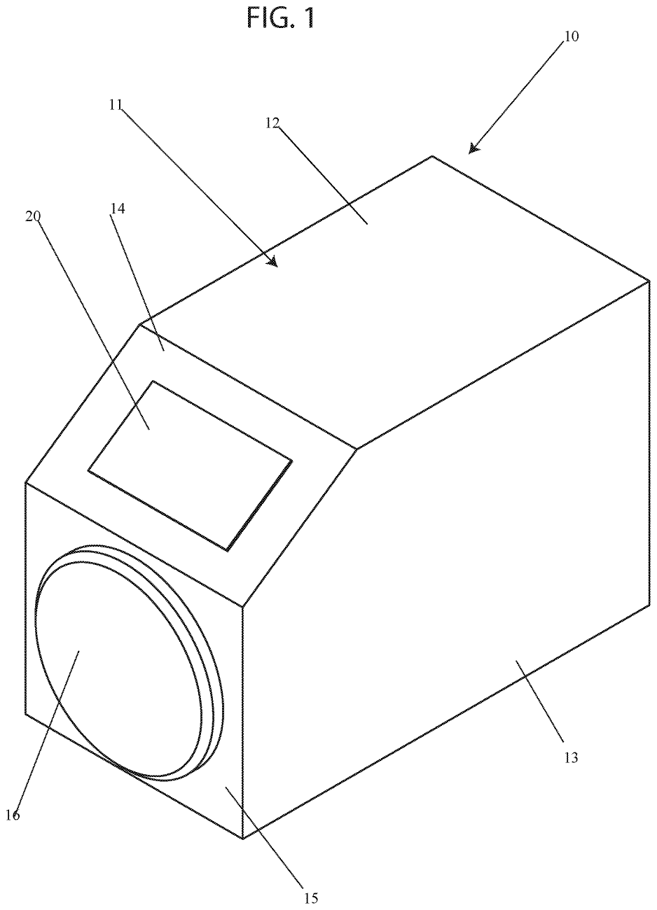

FIG. 1 is a perspective view of a washing machine and recycling unit 10 having an outer body or housing 11, the outer body includes a top surface 12, an angled front side 14, a front side 15, a cover 16. There is also a touch screen 20 shown as well as a side wall 13 of the housing.

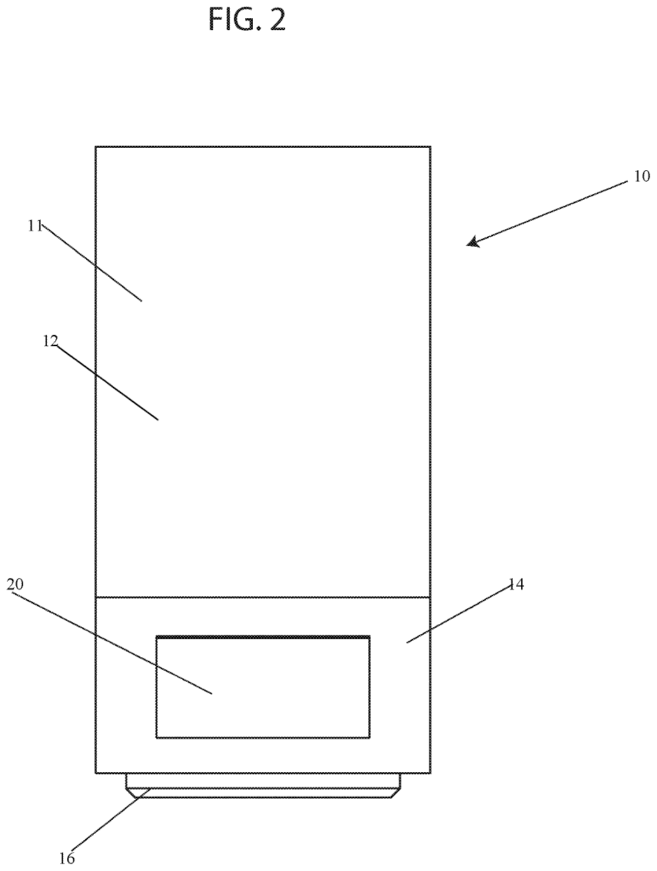

FIG. 2 is a top view of the embodiment shown in FIG. 1 which shows a washing machine and recycling unit 10 having a housing 11, and a top surface 12, as well as an angled front side 14, a cover 16 and a touch screen 20.

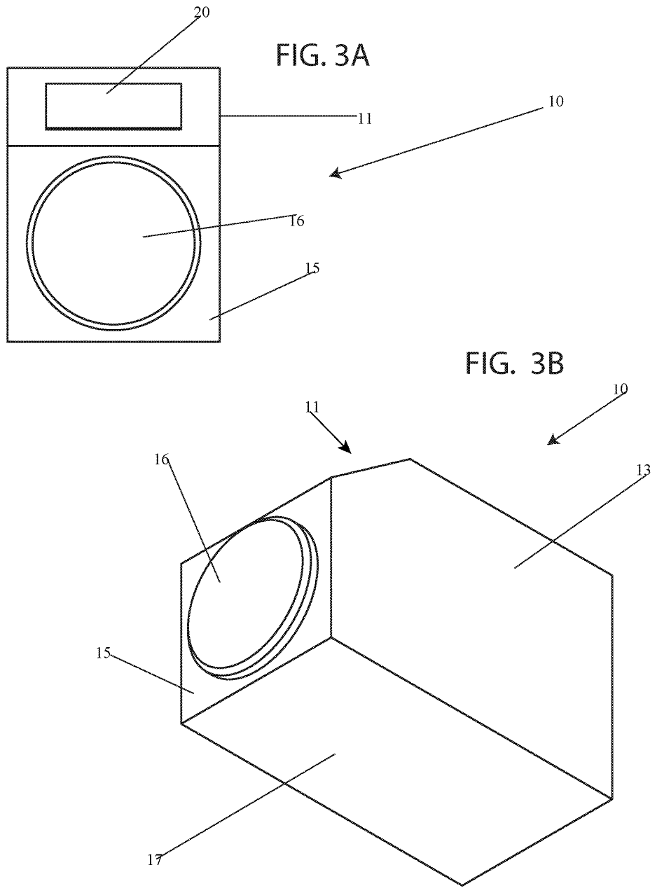

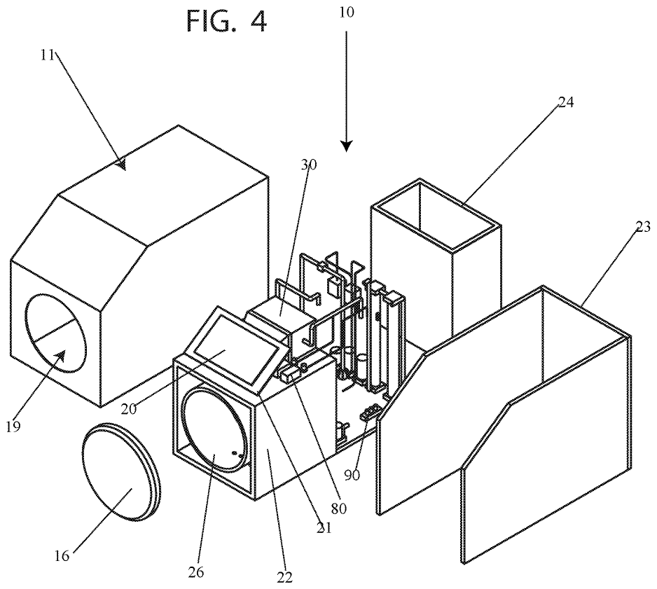

FIG. 3A shows the embodiment or recycling unit 10 having a front view which shows a housing 11 including a front side 15 and a touch screen 20. As shown in FIG. 3B there is a bottom perspective view which shows a housing 11 having a right side 13, a front cover 16, a front side 15 and a bottom side 17.

FIG. 4 is a perspective exploded view of the washing machine and recycling unit 10, with housing 11 and cover 16 removed, revealing opening 19, which allows materials to be inserted into the washing machine and recycling unit drum 26. There is also shown a touch screen 20, and an underlying interactive panel 21. There is also a dehumidifier 30, insulated panels 23, which have been removed and which normally surround the components, as well as a wastewater bin 24, which has been pulled out to show the other components. This view also shows a box 22 surrounding drum 26, as well as sensors 90 and a coagulant and flocculant assistant 80. The touch screen, along with the interactive panel, allows a user to control the device, including turning it on and operating it. The dehumidifier 30 is configured to pull water out of the air and input it into the wastewater or grey water bin 24. The coagulant and flocculant assistant is configured to remove coagulants from grey water after it has been used in a washing cycle and before the water is recycled for future use.

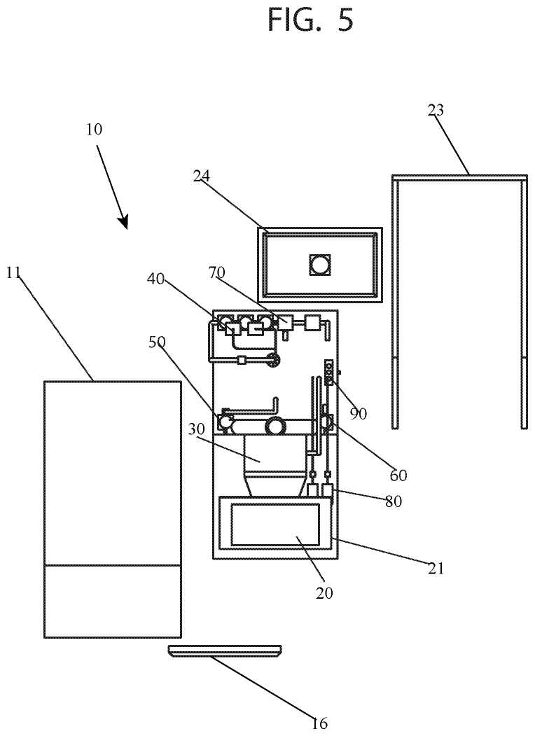

FIG. 5 is a top exploded view of the washing machine and recycling unit 10. This view shows the cover or housing 11, the touch screen 20, and the interactive panel 21. A cover 16 is also shown removed from housing 11. A dehumidifier is shown adjacent to the drum and adjacent to the wastewater bin 24. As this is an exploded view, the wastewater bin is shown removed and detached from the other components. There is also shown insulated panels 23 as well as an O₃ generator 40, a grey water pump 50 water pump 60 which pumps filtered water into the drum 26, a reverse osmosis filter 70, a coagulant and flocculant assistant, and sensors 90.

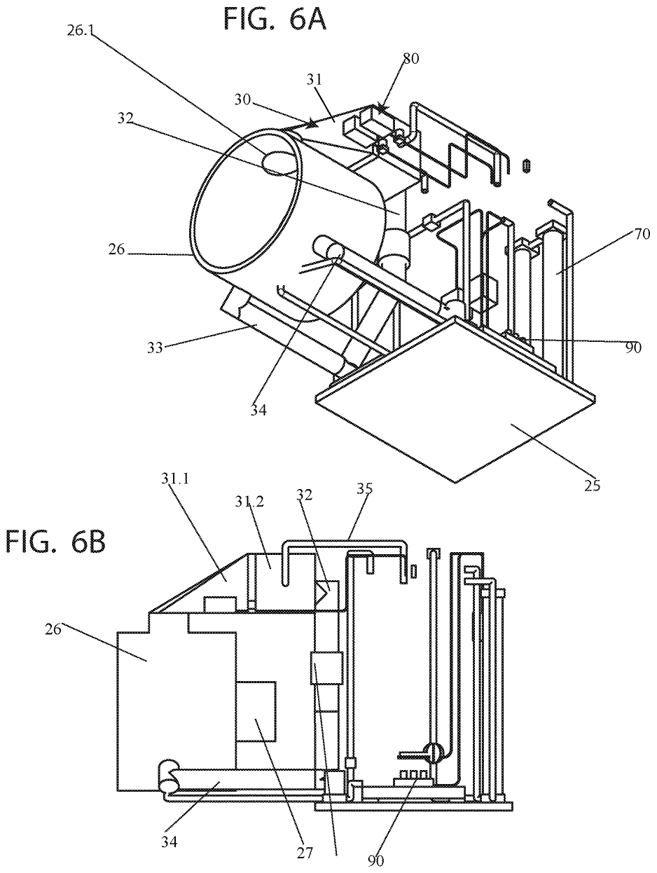

FIG. 6A is a bottom-front-right perspective view of the washing machine and recycling unit with the outer housing and wastewater or grey water bin removed. In this view, a flooring 25 is shown, as well as a dehumidifier 30, having a first arm 33 and a second arm 34 for recycling the air in the humidifier. An opening in the drum 26.1 is shown for drawing air into the humidifier body 31. Inside of the humidifier body is a HEPA filter. Water extracted from the dehumidifier is then sent to the grey water container or wastewater bin 24 via a feed line or pipe 35. In this way, the system can remain a self-contained recycling system that requires very little, if any, outside water input. There is also shown a coagulant and flocculant assistant 80, a reverse osmosis filter 70 sensors 90.

FIG. 6B is a side view of the washing machine and recycling unit shown in FIG. 6A with the outer housing and insulated panels being removed. In addition, the wastewater bin is also shown removed to show the parts feeding into or out of the wastewater bin. For example, there is shown the dehumidifier 30, which has a first body section 31.1, which draws the air out of the drum 26 and into the second body section 31.2. The air then flows down manifold 32 and back through the first part 33 and the second part 34. As shown, pipe 35 drains water from the dehumidifier to the grey water wastebin (not shown). Sensors 90 are also shown.

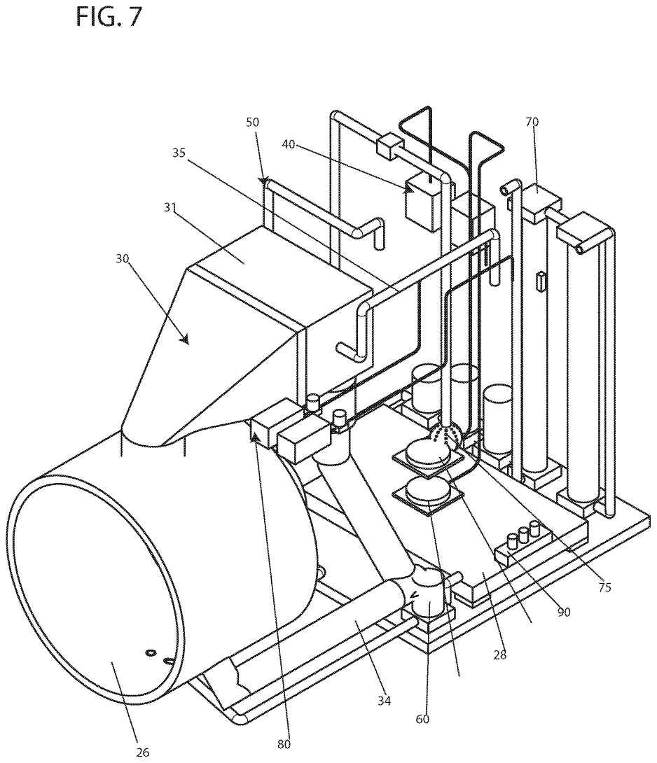

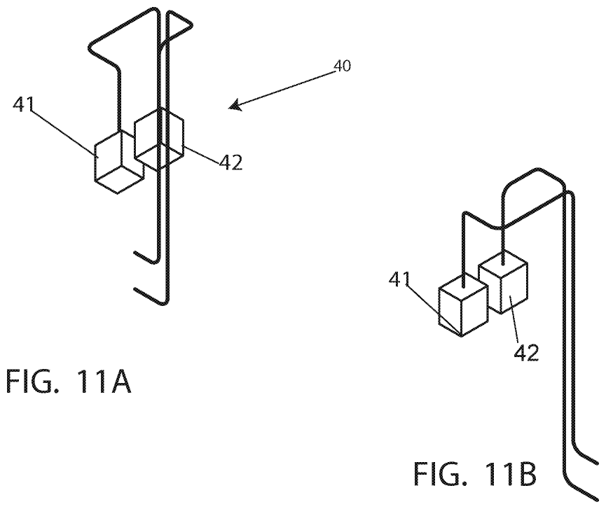

FIG. 7 is a perspective view of the washing machine and recycling unit shown in FIG. 11A. In this view, it is a perspective view with the outer housing 11, the insulated panels, and the wastewater bin shown removed. Dehumidifier 30 is shown adjacent to drum 26. The body 31 of the dehumidifier 30 is also shown with pipe 35 extending from the dehumidifier 30 into the wastewater bin 24, not shown. The washer grey water pump 50 is shown as well as the water pump 60. In addition, the O₃ generator 40 is shown as well as the reverse osmosis filter 70, which has a drain ball 75 that keeps sediments and other particulate matter from flowing into the drum 26. The coagulant and flocculant assistant 80 is also shown as well as sensor 90.

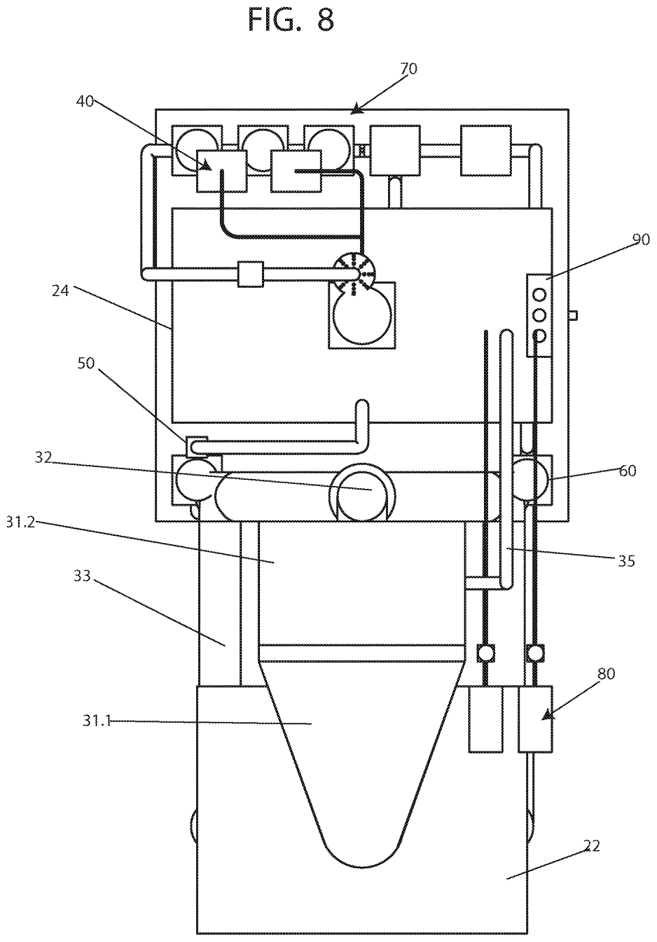

FIG. 8 is a top view of the embodiment shown in FIG. 6A. In this view, there is shown a dehumidifier 30 having a first housing section 31.1 and a second housing section 31.2. A first feed arm 33 is shown connecting to manifold 32. Outer cover box 22 is shown covering over drum 26. Feed pipe 35 shown feeding from the dehumidifier into the wastewater bin 24. In addition, grey water pump 50 is shown pumping or configured to pump water from drum 26 into wastewater bin 24. An O₃ generator 40 is also shown. Water pump 60 is configured to deliver water into the drum 26. Reverse osmosis filter 70 is also shown. Reverse osmosis filter 70 is configured to receive water from the wastewater bin 24 through drain ball 75. In addition, a coagulant and flocculant assistant 80 is also shown, as well as sensors 90.

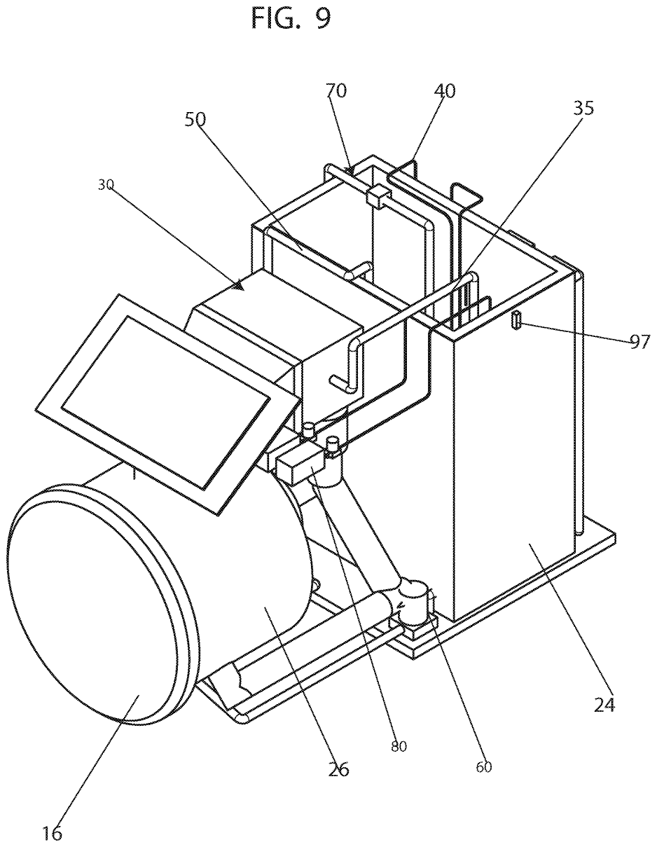

FIG. 9 is a perspective view of the washing machine and recycling unit with the outer cover removed, with the grey water bin 24 being present. In this view, there is shown drum 26, with cover 16. Dehumidifier 30, O₃ generator 40, washer grey water pump 50, water pump 60, reverse osmosis filter 70, coagulant and flocculant assistant 80, are all shown. In addition, an additional sensor 97 is shown coupled to wastewater bin 24.

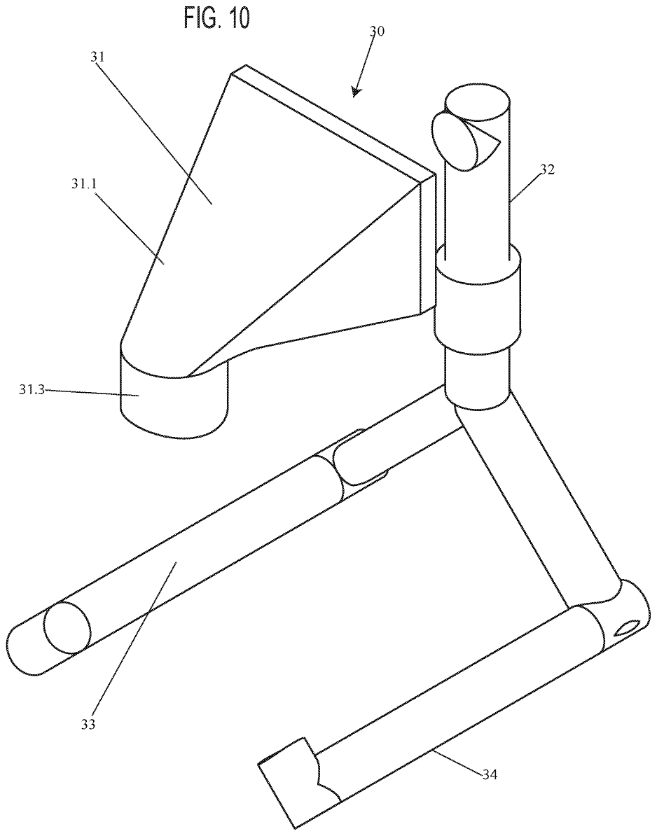

FIG. 10 is a perspective view of a portion of the dehumidifier. For example, in this view, dehumidifier 30 has a body section 31, having a first section 31.1, a connecting section 31.3, while the other body section 31.2 is shown removed. Manifold 32 is shown, which connects to other body section 31.2. Air flows through this manifold body section 32, then down into first arm 33 and second arm 34, creating a circulating system to drive air out of drum 26.

FIG. 11A is a bottom perspective view of the O₃ (ozone) generator. This O₃ generator 40 includes a graywater generator 41, which generates graywater Ozone in the wastewater bin 24. There is also a freshwater generator 42, which generates Ozone in the freshwater as well. FIG. 11B is a top perspective view of the O₃ generator.

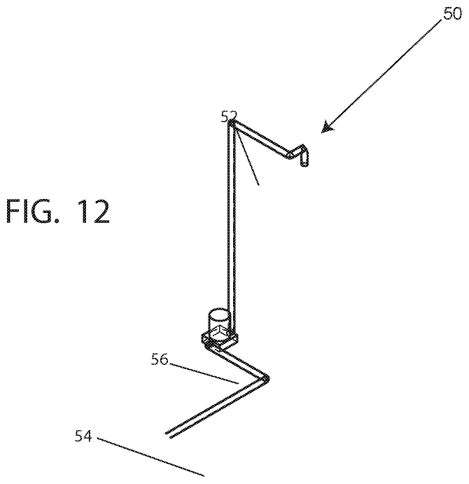

FIG. 12 is another perspective view of a grey water pump 50 which includes a feed line 52 which feeds in the wastewater bin 24, the pump itself 56, and a drain line 54, which drains water from drum 26 once the wash cycle is completed, so that this water from the drum 26 is fed into wastewater bin 24 so that it can be cleaned and recycled.

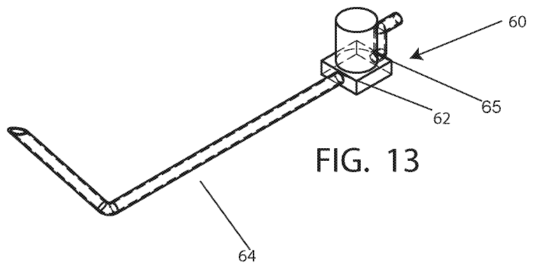

FIG. 13 is a perspective view of a water feed pump 60 which includes pump 62 and line 64. There is also a connector 65 which connects to freshwater so that water can be fed into drum 26.

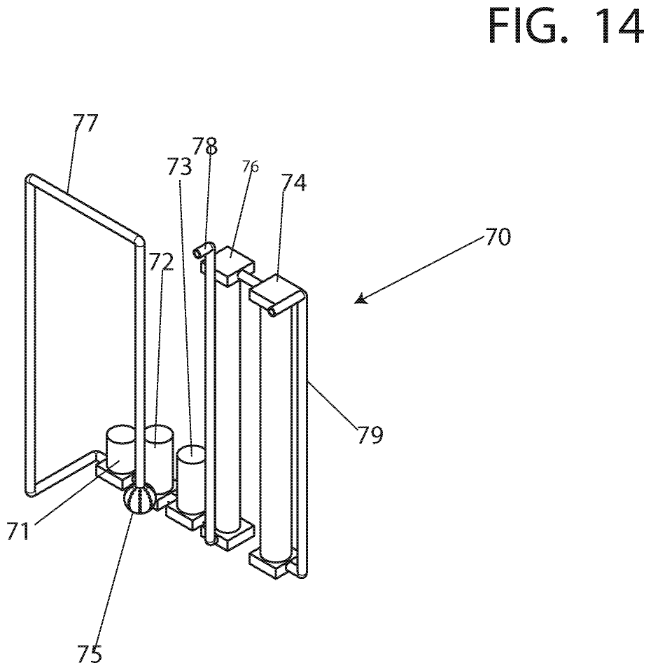

FIG. 14 is a perspective view of a reverse osmosis filter. This reverse osmosis filter 70 includes a sediment filter 71, a RO feed pump 72, a second RO feed pump 73, a UV filter 74, a drain ball 75, a UV filter 76, a graywater pipe 77, a wastewater pipe 78, in RO to UV pipe 79. Reverse osmosis filter 70 is configured to convert the graywater wastewater back into recycled freshwater for use in drum 26.

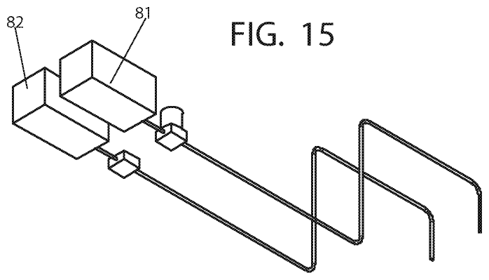

FIG. 15 is a perspective view of a coagulant and flocculant assistant 80. In this view, the coagulant and flocculant assistant includes a first coagulant generator 81 in a second coagulant generator 82. These coagulant generators are configured to reduce anticoagulants in line.

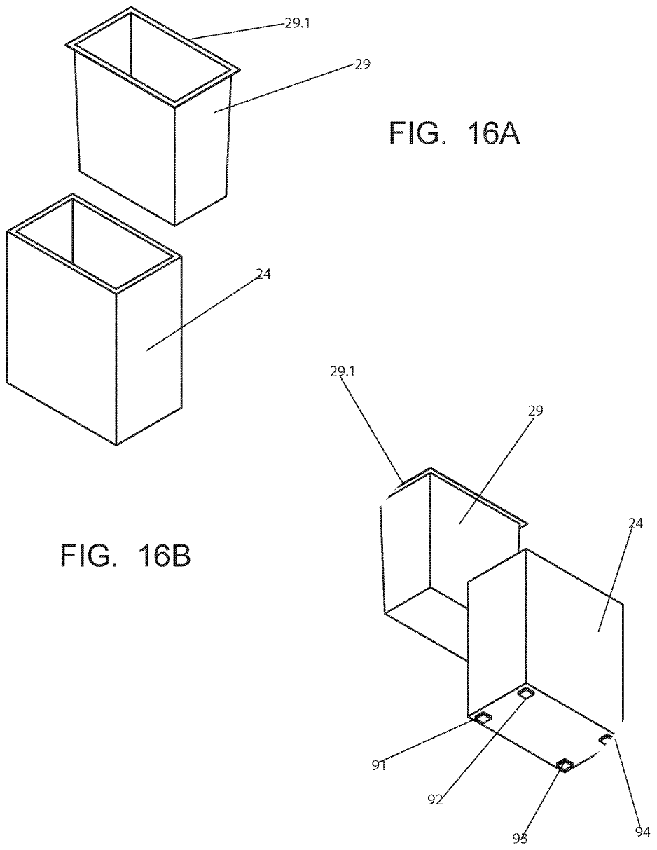

FIG. 16A is a perspective view of a wastewater bin 24 with the bladder 29.1. The bladder fits inside the wastewater bin 24. Bladder 29 has a rim 29.1, which allows the bladder to sit above bin 24.

FIG. 16B is a perspective exploded view of the wastewater bin 24 and the bladder 29, which also shows bin 24, bladder 29, and rim 29.1. Also shown are sensors 91, 92, 93, and 94, which measure the weight of the water in wastewater bin 24.

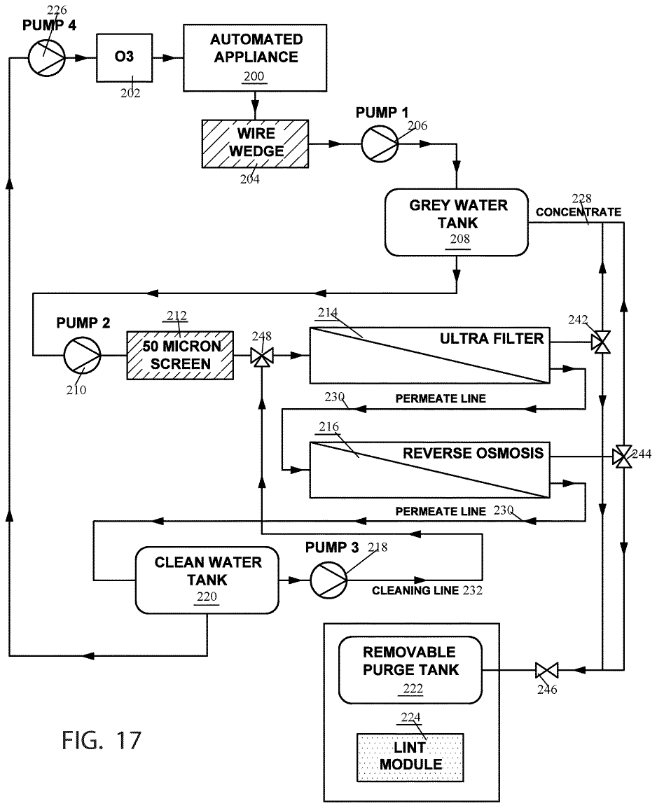

FIG. 17 is a flow chart and schematic layout for the progression of water and/or fluids in a system of an automated appliance 200. For example, the automated appliance 200 may initially contain water or fluid that is input into the system, so that once this water or fluid is input into the system, it does not need to be replenished for at least a few cycles. Water or fluid flows from the automated appliance through a wire wedge 204, which screens this water for particulates. The water or fluids are drawn through the wire wedge 204 via a first pump 206. First pump 206 then pumps this water into a grey water tank 208. A cleaning concentrate is then input into grey water tank 208 via at least one concentrate line 228. The combination of grey water and concentrate is then drawn via a second pump 210 through a subsequent 50-micron screen 212. While a 50-micron screen is mentioned, any suitable-sized screen can be used. This fluid then passes through a three-way valve 248 to an ultra-filter 214. This fluid is then filtered in the ultra-filter. The ultra filter is a filter that is any size smaller than the 50-micron screen 212. The fluid then flows through a permeate line 230 to a reverse osmosis filter 216 for further cleaning. Once the reverse osmosis filter further filters the fluid, it is pushed by pump 210 to clean water tank 220. Water from clean water tank 220 is then drawn by pump 218 back to three-way valve 248 for further recycling by the ultra-filter and the reverse osmosis filter. Alternatively, the ultra-filter 214 can feed particulates into a removable purge tank 222 via a three-way valve 242. Furthermore, reverse osmosis filter 216 can feed impurities and particulates to purge tank 222 via three-way valve 244. Once the water is sufficiently cleaned in clean water tank it is drawn via a fourth pump 226 back to an O3 or ozone cleaner 202 wherein the water is then fed back into the automated appliance 200.

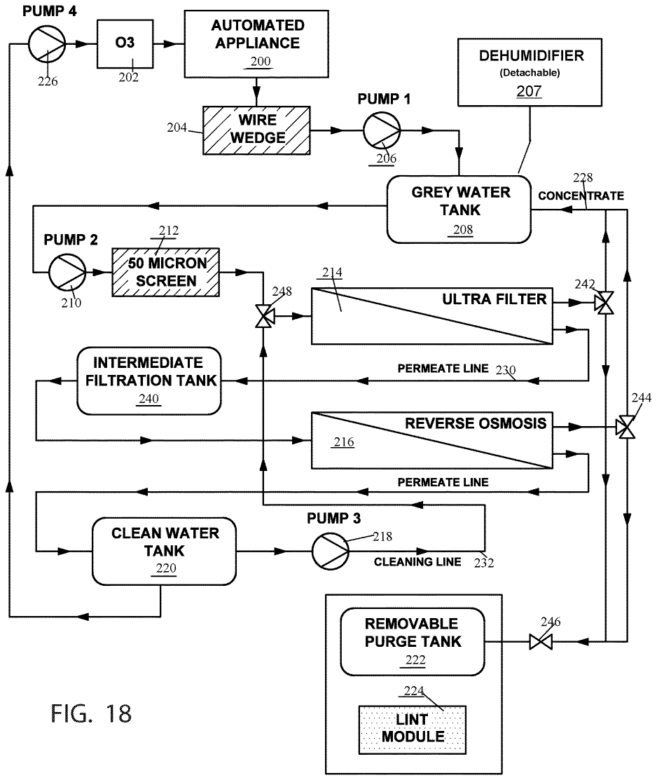

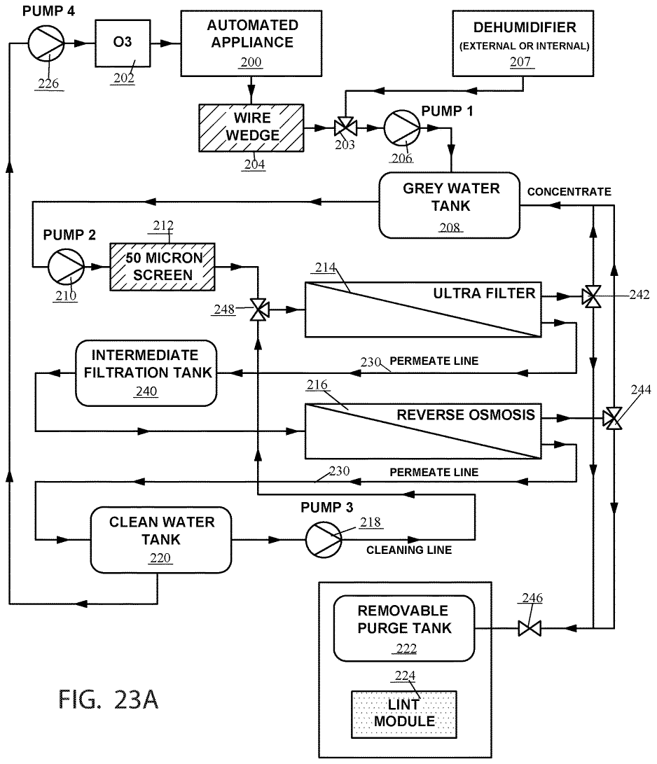

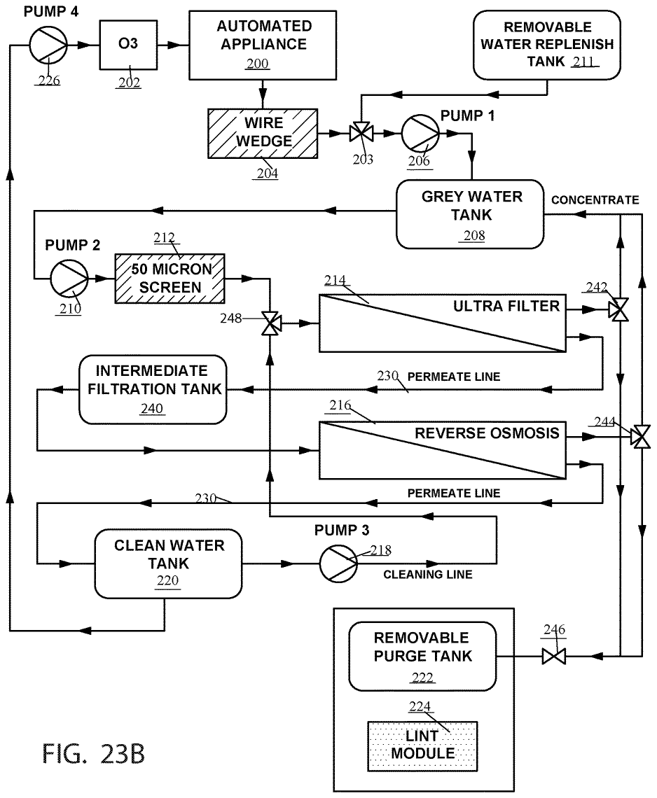

FIG. 18 is a view of an alternative embodiment which shows the same components as shown in FIG. 17. For example, there is shown the automated appliance which can be in the form of, for example, a dishwasher, a washing machine, or any other suitable appliance. The output of the automated appliance feeds into a wire wedge 204, which has an output that feeds into a first pump 206. First pump 206 pumps this water into a grey water tank 208. There is also an optional dehumidifier 207, which can remove water from the air and feed it into the grey water tank 208. A second pump 210 draws water from the grey water tank 208 and feeds this water into the 50-micron screen 212. This 50-micron screen can be a 50-micron screen, but it can also be any suitable size screen such as a screen having holes ranging in size from 10 microns to 100 microns. The output of screen 212 feeds into the three-way valve 248 and the ultrafilter 214. Ultra filter 214 can be a filter with holes or pores of 0.001 microns or larger. Ultra filter 214 then feeds through valve 242 into intermediate filtration tank along permeate line 230. Fluid in intermediate filtration tank 240 is then fed into reverse osmosis tank 216. The reverse osmosis tank has a 0.0001-micron filtration filter, which is configured to remove additional particulates from the fluid or water. While 0.0001 is used as a target size for the pores or openings, the filtration system could be set to filter out particulates in a range smaller than 0.0001. In at least one embodiment, the pore sizes can fall below 0.0001 microns. Fluid from reverse osmosis tank 216 is then drawn by third pump 218 into clean water tank 220. Fluid from the clean water tank 220 can then be drawn by a fourth pump 226, wherein this fluid is sent into the ozone generator (O3 generator) back into the automated appliance. In addition, on a periodic basis, materials and/or fluid from the ultra-filter 214 and the reverse osmosis filter 216 can be flushed to the removable purge tank 222, such that the removable purge tank then takes these particulates, which can then be either mechanically or manually removed from the system. As shown in FIG. 23 the particulates from the removable purge tank 222 can be positioned adjacent to the lint module 224.

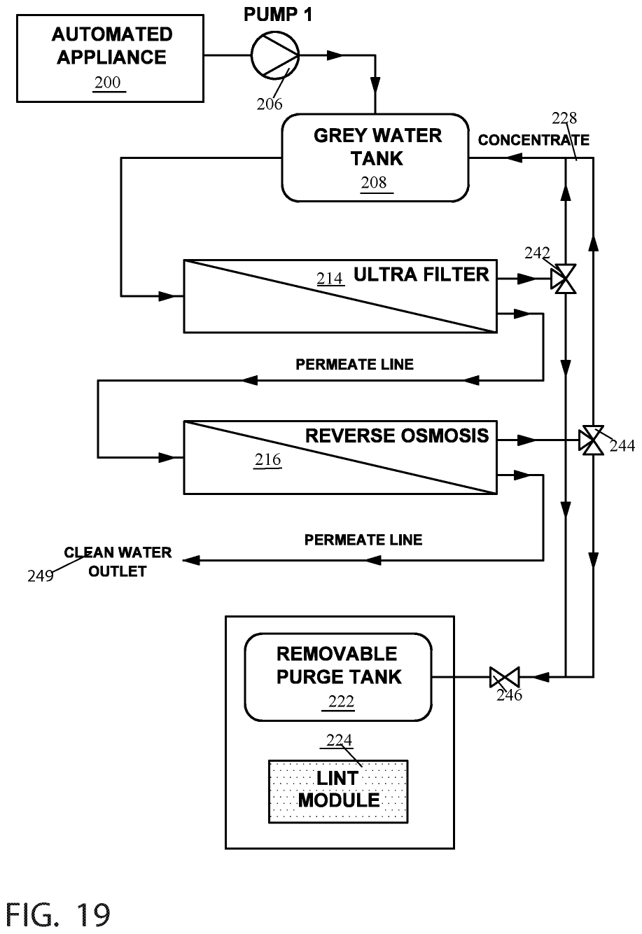

FIG. 19 is a view of a simplified flow chart showing the automated appliance 200, which feeds into the first pump 206. This fluid then flows into grey water tank 208. Grey water tank 208 is configured to receive fluid or water or used water from the automated appliance 200, as well as from the ultra-filter tank 214, and the reverse osmosis tank 216 via concentrate line 228. Water or fluid flows from the grey water tank 208 into the ultra filter tank 214, where it is filtered by the ultra-filter. Next, water from the ultra-filter tank 214 flows through the permeate line 230 into the reverse osmosis tank 216. Next, water then flows to clean water outlet 249 and then back to the automated appliance or to the community water system. Removable purge tank 222 is also configured to receive fluids into tank 222, which is positioned adjacent to lint module 224.

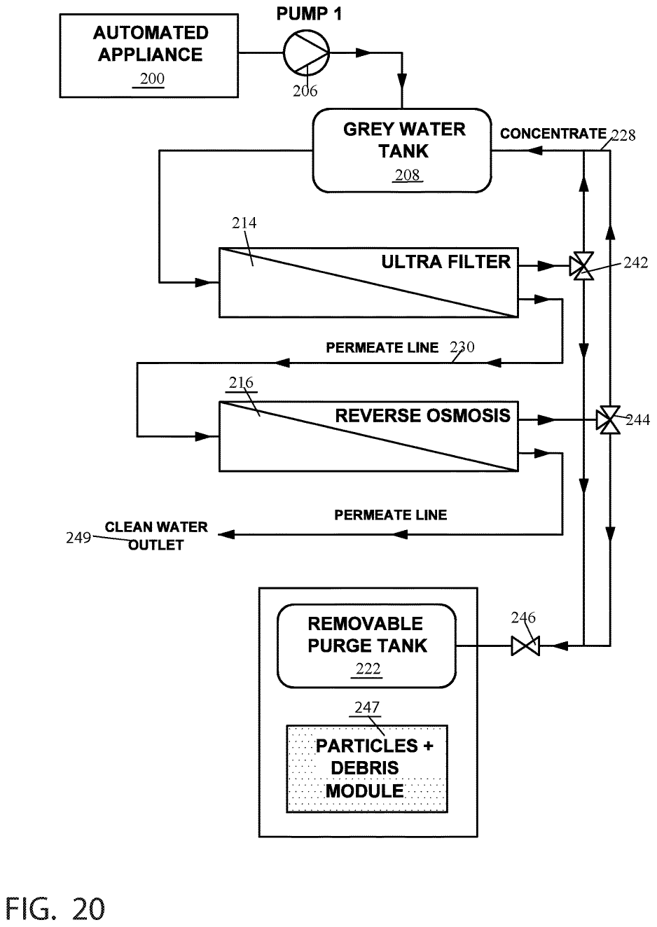

FIG. 20 shows another system that includes an automated appliance 200 that feeds fluid and/or water into a first pump 206. This fluid then flows into grey water tank 208. Fluid from the grey water tank 208 then flows to the ultra filter 214. This water then flows through permeate line 230 into reverse osmosis tank 216. Next, this fluid flows through the permeate line into the clean water outlet 249. In this design, a removable purge tank 222 and a particles-and-debris module 247 are also shown.

The fluid flow through all these designs shown in FIGS. 17-24 is controlled by different pumps that provide negative (pulling) pressure through the system. In addition, the flow of this water or fluid through the system is also controlled via solenoid valves such as valves 242, 244, 246, 248, as well as pumps 206, 210, 218, and 226. The control of these valves and pumps can be controlled by a central controller, which is configured to control the flow of fluids through a wash, rinse, and purge cycle. The wash cycle occurs when water flows into the automated appliance and is used to wash objects such as clothes or dishes. The rinse cycle occurs when the soapy water is purged from the system and sent to the grey water tank 208 for recycling while water is introduced into the appliance for rinsing the objects. During the rinse cycle, the soapy water is then recycled and fed back into the system. Once the rinsing water is purged from the system, it is recycled through the recycling system. The cleaning of the water or fluid can be performed in a multi cycle process wherein water can flow from the grey water tank 208, through to the 50 micron screen 212, through the ultra-filter 214, this water can then be optionally recycled back to the grey water tank or sent on to the reverse osmosis tank 216. Water or fluid from the reverse osmosis tank can then be sent back to the grey water tank for more recycling. Alternatively, the water from the clean water tank can be recycled back to the ultra-filter through valve 248 for further cleaning through cleaning line 232. In this way, if the water or fluid is not cleaned in the first pass, it can be cleaned further via further cycles.

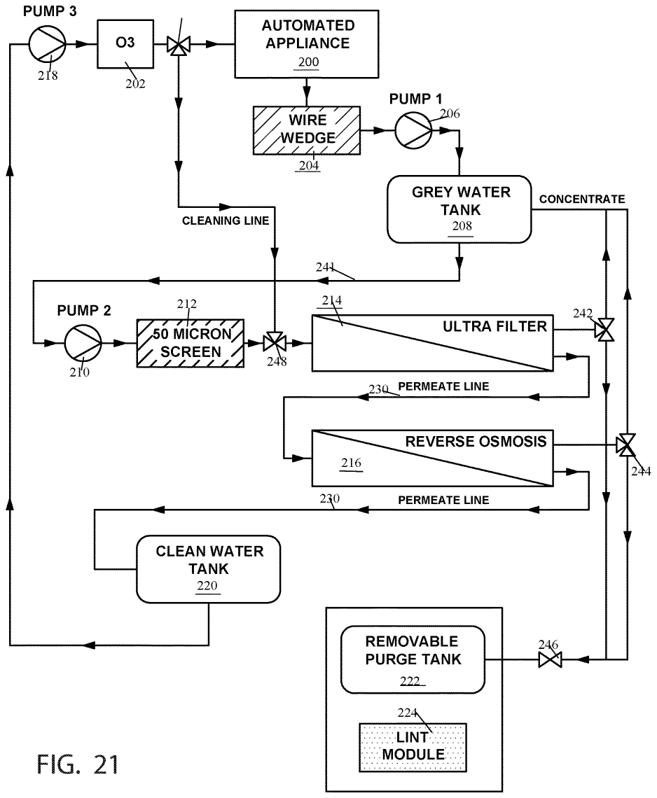

FIG. 21 shows another view, which shows an automated appliance 200 that feeds into a wire wedge 204 and then into a pump 206. Pump 206 pulls the fluids from automated appliance 200 via a negative pressure and then umps this fluid into grey water tank 208. A second pump 210 then draws this fluid into screen 212 through valve 248 and into filter 214 along line 241. Water or fluid then flows into valve 242 which selectively allows fluid to be recycled back into grey water tank 208. Alternatively, valve 242 can be set to be closed from the input of ultra filter 214 to allow fluid to flow through permeate line 230 and then into reverse osmosis filter 216. Fluid from reverse osmosis filter 216 can be either recycled back to grey water tank 208 if valve 244 is open or sent through permeate line 230 to clean water tank 220 when a third pump 218 is running.

Alternatively, during a purge cycle, fluid can flow from reverse osmosis filter 216 with particulates through valve 244 to valve 246 and into removable purge tank 222.

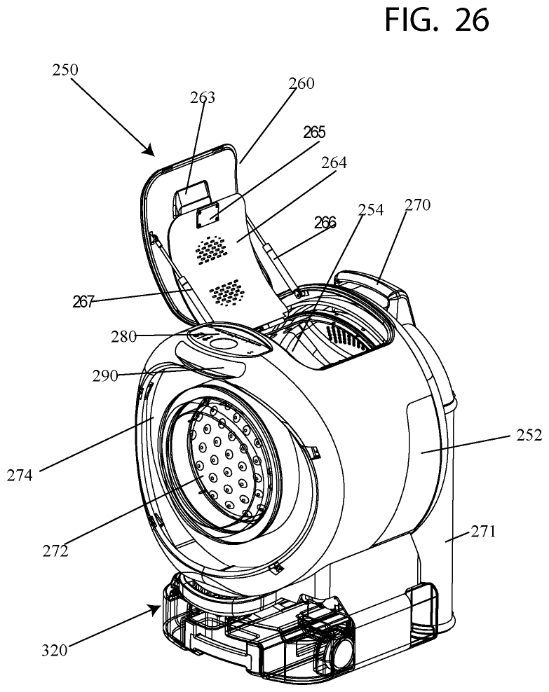

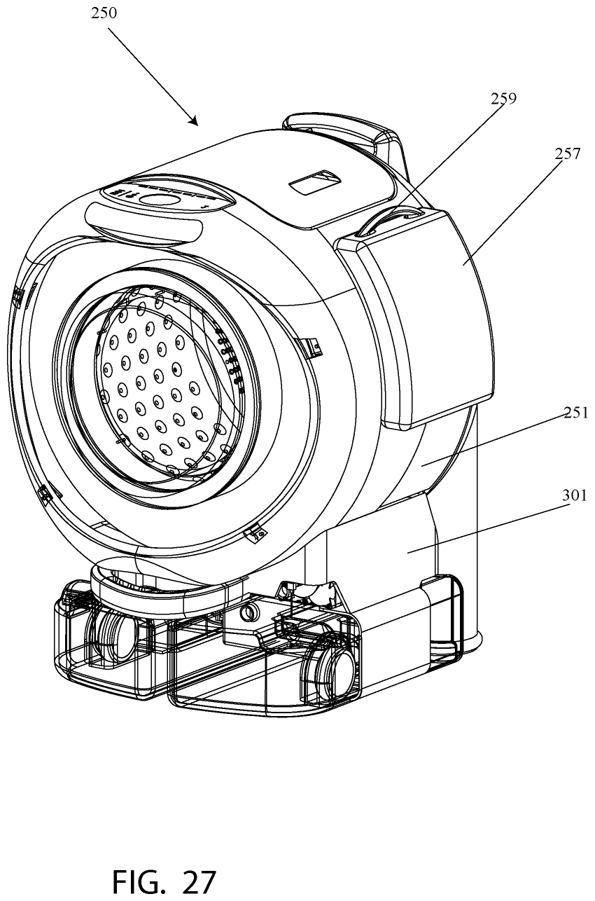

Removable purge tank 222 can be optionally positioned adjacent to lint module 224 so that both components can be optionally manually purged from the system by a user via an accessible housing such as housing or compartment 257 in FIG. 27. Alternatively, once the fluids are drawn by the third pump 218, they are driven through the ozone generator 202, through the valve 203, and then back into the automated appliance 200. If the system determines that the fluid being pumped by third pump 218 is not sufficiently clean, it can instead be recycled back into the system through valve 248 wherein this fluid is then sent back into ultra filter 214.

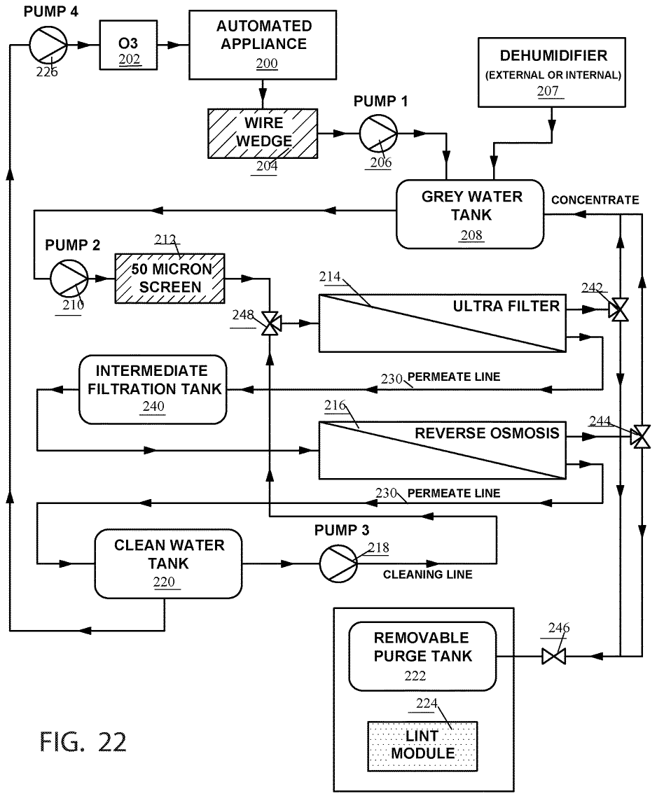

FIG. 22 shows the flow of fluids through the system in an alternative embodiment. In this embodiment there is an automated appliance 200, a wire wedge 204, a first pump 206, which feeds water into grey water tank 208. There is also a dehumidifier 207 which can be positioned either external to the automated appliance or housed internal in the automated appliance. Dehumidifier 207 is configured to provide additional water drawn from the air into the system so that the system does not need to draw on much if any additional water from a direct water supply. Water or fluid from dehumidifier 207 is then sent into grey water tank 208. Pump 210 draws this fluid from tank 208 into screen 212. Fluid flows through valve 248 into ultra filter 214 and then on through permeate line 230 or through valve 242. If the fluid flows through valve 242 it flows back into grey water tank 208. Fluid flowing through permeate line 230 then flows into intermediate filtration tank 240 wherein the fluid is further filtered. Next, third pump 218 draws this fluid into reverse osmosis filter 216 from permeate line 230. From reverse osmosis filter 216 it flows into clean water tank 220. Water is then drawn from clean water tank 220 via fourth pump 226, back through ozone generator 202 and then back into the automated appliance 200. Alternatively, water is drawn through valve 244 to removable purge tank 222 during a purge cycle or back to grey water tank 208 during a recycling cycle.

FIG. 23A is a design that is essentially similar to the design of FIG. 22. However, with this design, dehumidifier 207 feeds into valve 203, which then feeds into first pump 206 and then into grey water tank 208.

FIG. 23B is a design that is essentially similar to the design of FIG. 23A however with this design a removable water replenishment tank 211 can be used instead of a dehumidifier 207. Thus, removable water tank which can be in the form of a one gallon, a three-gallon, five gallon or any other suitable sized tank which has an output which feeds into valve 203. First pump 206 then draws water from this removable water tank into grey water tank 208 for input into the recycling cycle.

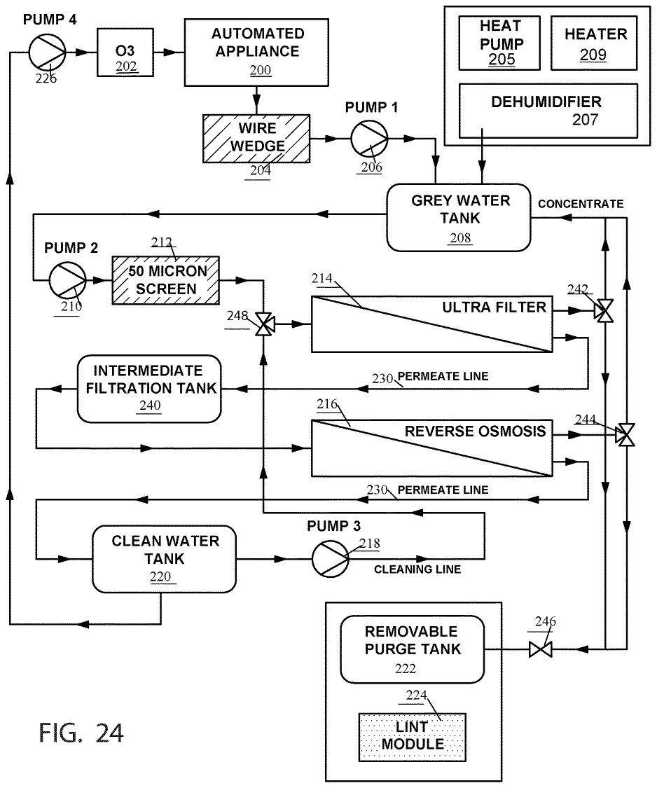

FIG. 24 is another design similar to that of FIG. 23B. However, this design includes both a heat pump 205, as well as a heater 209, and a dehumidifier 207. The heat pump 205 is for heating up the heater 209 to work in conjunction with dehumidifier 207 to create cooling coils to attract water and to draw water out from the drum (see drum 254 in FIG. 26) to dry the clothes. In addition, by drying the clothes with a dehumidifier, the water drawn from the clothes can then be recycled back into the grey water tank 208 wherein it is then subsequently filtered. This view also shows the other components of FIG. 23B including the filters 214, and 216, tank 240, and tanks 220 and 222, solenoids 242, 244, 246, 248, pumps 206, 210, 218 and 226 ozone generator 202, automated appliance 200, wire wedge 204, screen 212, permeate line 230, as well as lint module 224.

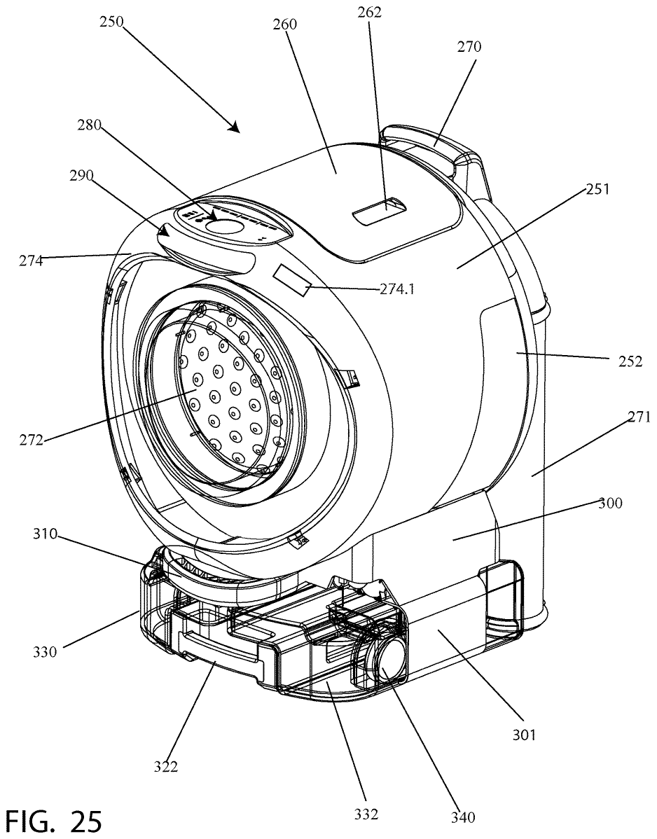

FIG. 25 shows a perspective view of the one embodiment of an appliance 200.

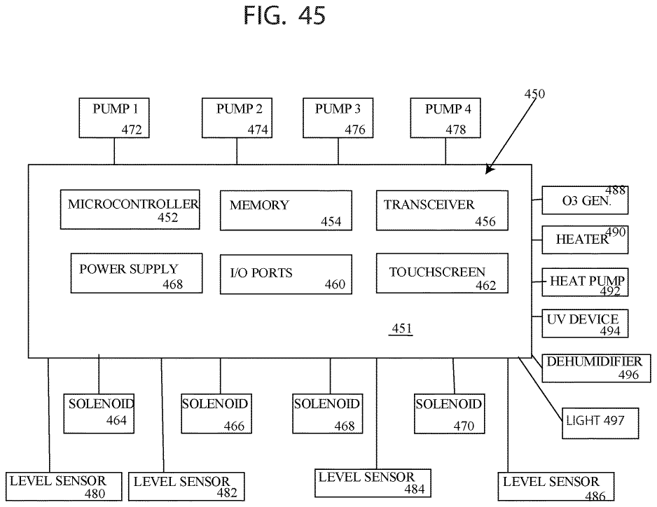

For example, this appliance 250 is a washing machine which has a housing 251, having a side door 252. There is also a drum 254 (FIG. 26) which is disposed inside of the housing. There is also a top door 260 which is configured to open to allow for clothes to be added to the inner area adjacent to the drum 254. A handle 263 allows the user to grip the top door 260 to open the top door (FIG. 26). A back handle 270 is positioned adjacent to the top door 260. This handle 270 allows for easy handling and movement of the device. A back stand 271 is configured below handle 270. Back stand 271 can also form the cover for much of the components shown in FIGS. 22-24D. A front door 272 shows the washing of the clothes inside of the housing 251. The outer frame forms a front round interface 274 and is configured to sit around front door 272. Disposed on this outer frame 274 is an optional light 274.1 which can be used to indicate a state of the appliance 250 (See light 497 in FIG. 45). Control panel 280 contains electronic buttons for controlling the operation of the device. On the front face is a detergent container 290 which is configured to receive a detergent cartridge. A bottom stand 300 is configured to support the body section or housing 251. Disposed inside of bottom stand 300 are also some of the components found in FIGS. 22-24D. There is also a handle 310 and a handle 322 for the bottom stand or lower housing 301. Side tanks 330 and 332 are positioned adjacent to handle 322.

FIG. 27 shows a perspective view of another embodiment of an appliance such as appliance 250 which includes a housing 251, a base 301 as well as a side compartment 257 having a handle 259. This side compartment 257 is configured to be removable to allow either a purge tank such as purge tank 222 or a lint module 224 to be removed from the housing. Once the purge tank 222 and the lint module 224 are removed they can be cleaned and then reinserted back into compartment 257 or housing and then reattached to the appliance 250. This housing is shown rounded or curved so that when it attaches to the housing it can conform to the housing.

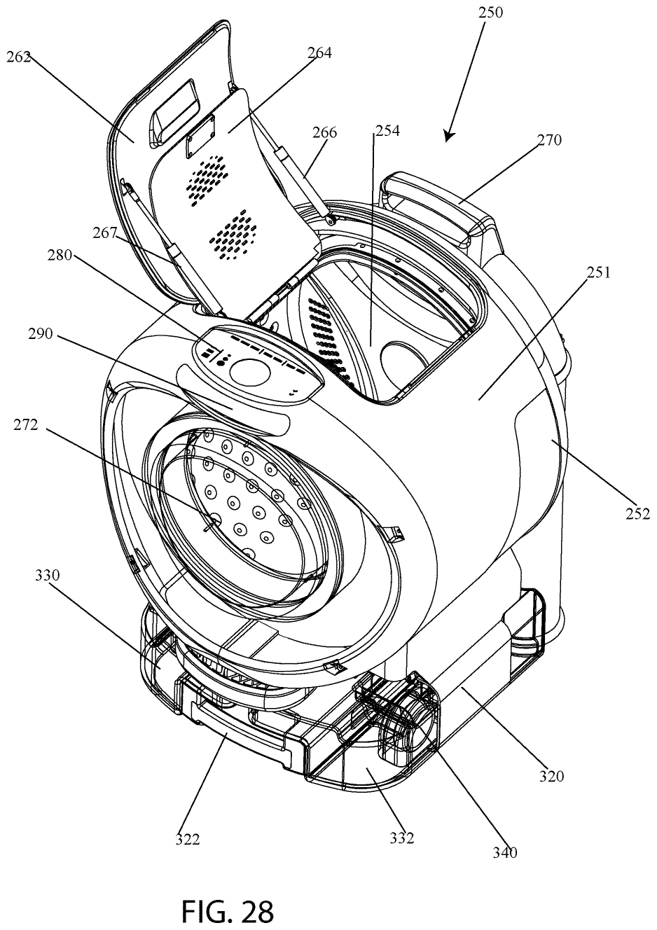

FIGS. 26 and 28 show the device as described in FIG. 25 with the top door 260 being in an open position. Top door 260 includes handle 263 as well as screen 264. Screen 264 has a screen opening 265 which allows for handle 263 to fit therethrough. Supporting top door 260 are arms 266 and 267. These arms 266 and 267 have pistons which allow for the support of top door 260 in an open position. This view shows side door 252, drum 254, handle 270, back stand 271, front door 272, round interface 274, control panel 280, detergent container 290 as well as bottom stand 320.

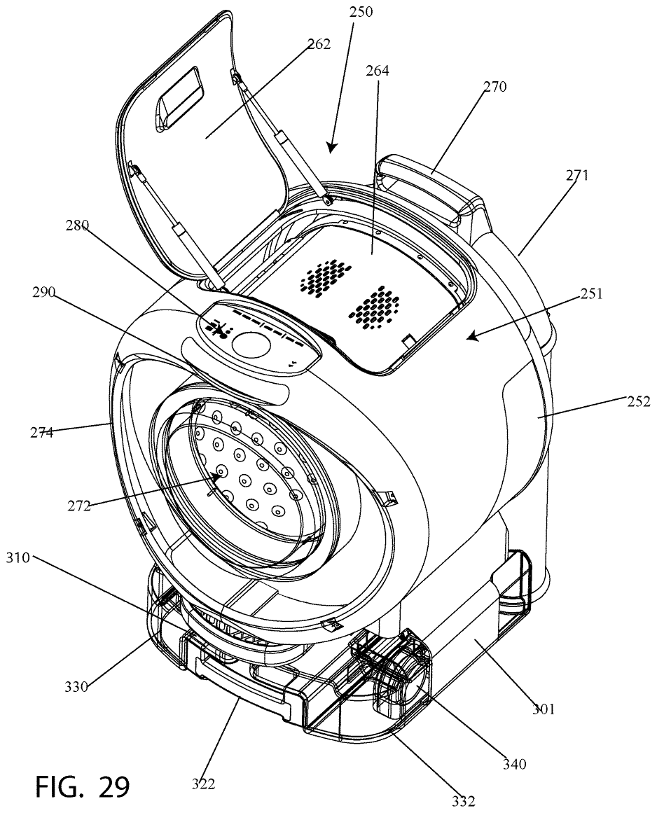

FIG. 29 shows a top view of the device 250 which shows housing 251, top door 260 which has an inner side 262. There is also screen 264 which is shown closed. Handle 270 is positioned adjacent to screen 264. Handle 270 is positioned above back stand 271. Side door 252 is also shown on housing 251. Front door 272 is shown adjacent to front round interface. Control panel 280 is shown above detergent container 290. Bottom stand 300 includes lower portion 301 as well as handles 310 and 322. Side containers 330 and 332 are also shown. Wheel 340 is disposed inside of bottom stand 300.

FIG. 30 shows a view which has the purge tank housing 321 being shown as being removed via handle 322 from the lower housing 301. Purge tank housing 321 is positioned adjacent to handle 310 and adjacent to side tanks 330 and 332. This purge tank housing 321 has a purge tank groove or slot 326 which allows the purge tank to be selectively inserted and/or removed from the lower housing 301. This view also shows housing 251, side door 252, top door 260, handle 270, back stand 271, front door 272, front round interface 274, control panel 280 and detergent container 290.

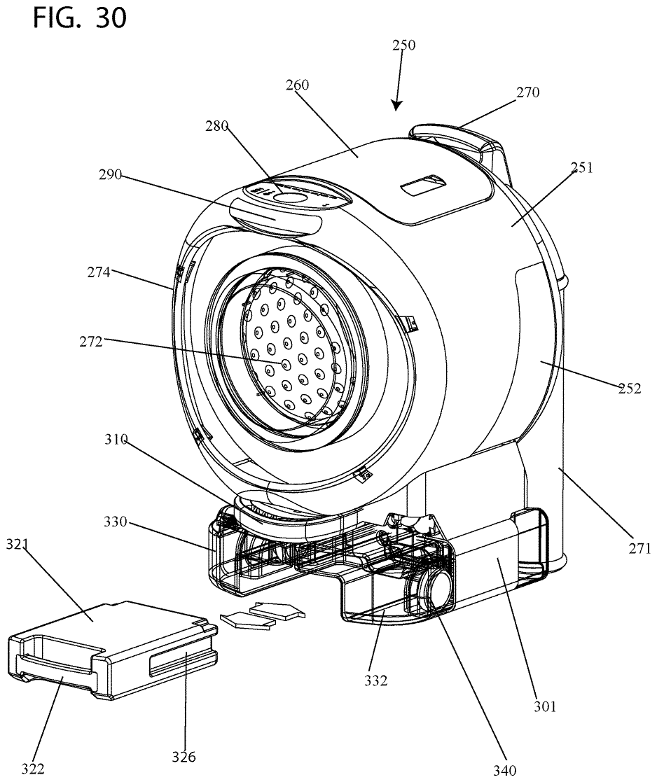

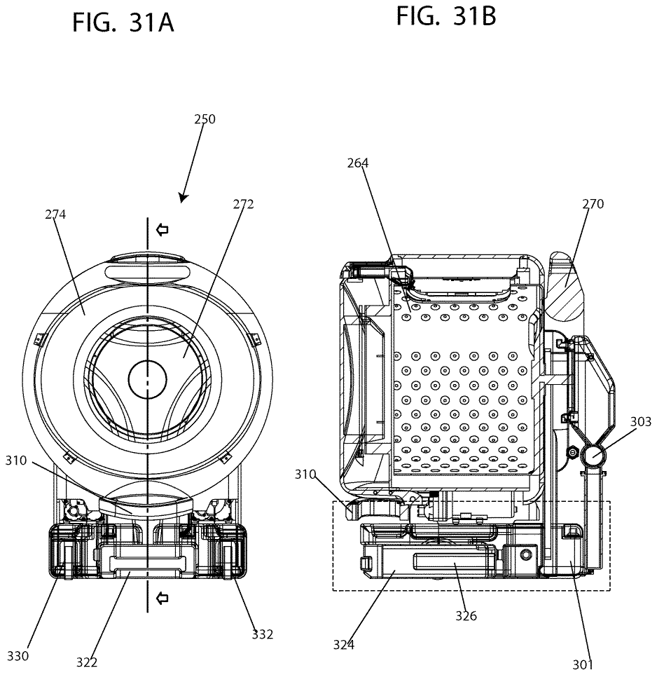

FIG. 31A shows a front view of the device 250 which shows front round interface 274 surrounding front window/door 272. There is also handle 310 positioned below front door/window 272. Purge tank handle 322 is shown positioned between tanks 330 and 332. FIG. 31B shows a side cross-sectional view taken along the line shown in FIG. 31A. In this view there is shown handle 270, drum 264, front handle 310, lower housing 301 having purge tank 324 (disposed inside of purge tank housing 321), and slot 326 for purge tank 324. There is also shown a port 303 which is configured to receive outside input of fluid such as fluid from an outside water line. This port 303 allows for the input of water to either automated appliance 200, or to grey water tank 208 shown in FIG. 22.

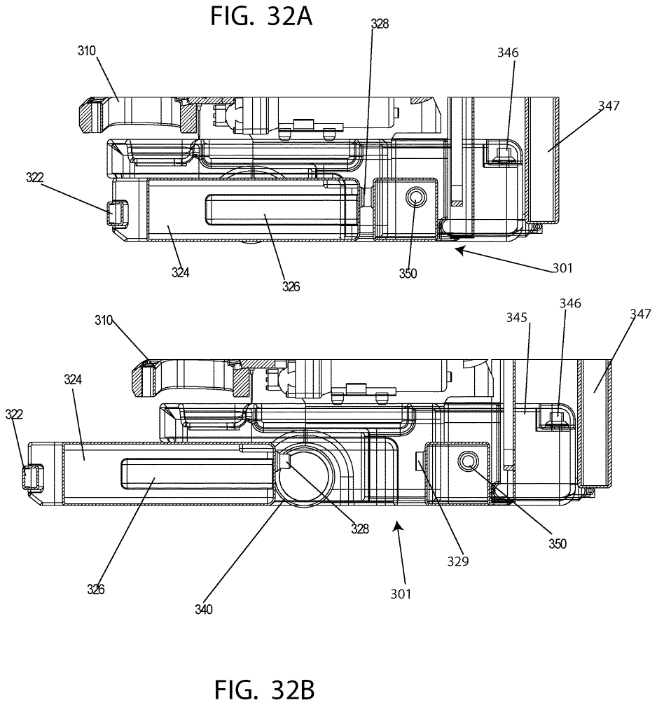

FIG. 32A shows a side view of the lower housing 301. Lower housing 301 includes a back tank 347, which can be filled with any one of the tanks shown in FIG. 22. There are also shown ports 346, 350 and 328 which are configured to receive fluid into the system. Purge tank 324 is shown having slot 326 and handle 322. Handle 322 allows for the purge tank 324 to be pulled away from lower housing 301 so that port 328 separates from port 329 (See FIG. 32B). A wheel 340 is shown in FIG. 32B as well.

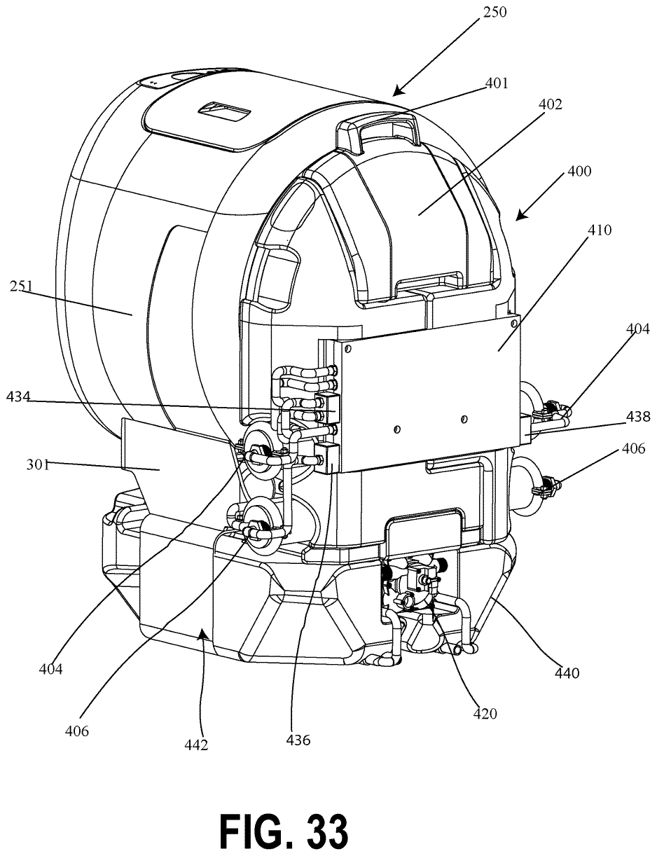

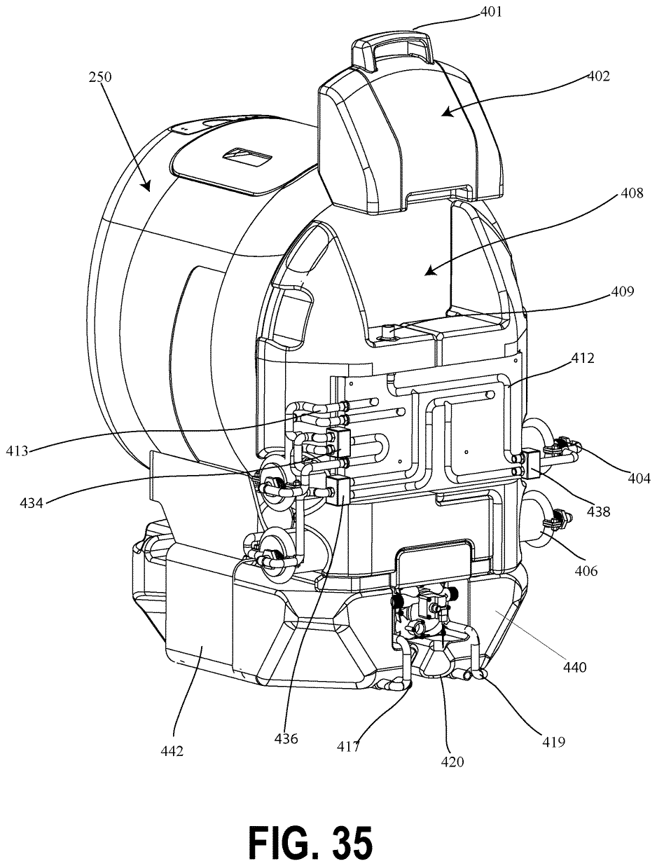

FIG. 33 is a back view of another embodiment, which shows device 250 which has housing or body section or housing 251 with a modular back housing recycling unit 400 coupled to the device 250. This modular recycling unit 400 includes a handle 401 and a removable purge container 402. There is also a back panel or plate 410 which covers a manifold 412 (See FIG. 35). In this view there is shown solenoid valves 434, 436 and 438. There are also shown filter housings 404 and 406. Filter housing 404 is for housing a filter such as the ultra-filter 214 or any other suitable filter such as the reverse osmosis filter 216. Alternatively, filter housing 406 is for housing a filter such as reverse osmosis filter 216 or any other suitable reverse osmosis filter 214 as well. Adjacent to the filter housings 404 and 406 is the lower portion of the bottom stand 301. There is also shown clean water tank 442 and grey water tank 440 which sit at the bottom of bottom stand 301.

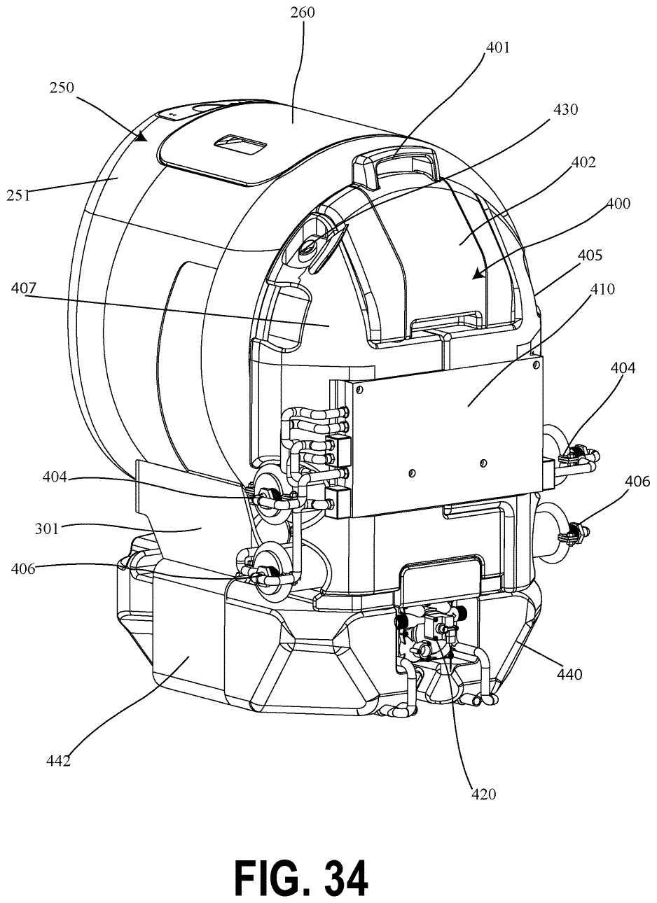

FIG. 34 shows a back perspective view of the device having recycling unit 400. In this view there is shown top door 260 on device 250 as well as housing 251. Handle 401 is shown adjacent to removable purge container 402. Back panel or plate 410 is shown adjacent to filter housings 404 and 406. An external water input port 430 is shown adjacent to purge tank 402 in side panel tank 407 which serves as a clean water tank (see clean water tank 220 in FIG. 17-24. Another side tank 405 is configured for the grey water tank (See grey water tank 208 in FIGS. 17-24). There is also shown lower portion of bottom stand 301 which shows lower manifold 420 which feeds into manifold 412 (See FIG. 35).

FIG. 35 shows a back perspective view of the modular recycling system 400 which shows handle 401, removable purge tank 402 being removed from the rest of the device. There is also shown device 250. In this view back plate 410 is shown removed and manifold 412 is exposed as well as side manifold 413. These manifolds include piping which is configured to allow for the flow of the recycled grey water through the system as well as for the flow of the clean water through the system, through the solenoids 434, 436 and 438 as well as through the different stages of filtration such as through filter housings 404 and 406. The removal of removable purge tank 402 shows opening 408 as well as port 409 which allows for the feed into the manifold 412. These manifolds 412, 413 and 420 allow for the connection of lower clean water tank 442 to upper tank 407 and allow for the connection of upper grey water tank 405 to lower grey water tank 440. Manifold 420 includes pipe 417 which feeds into lower clean water tank 442, while pipe 419 feeds into lower grey water tank 440.

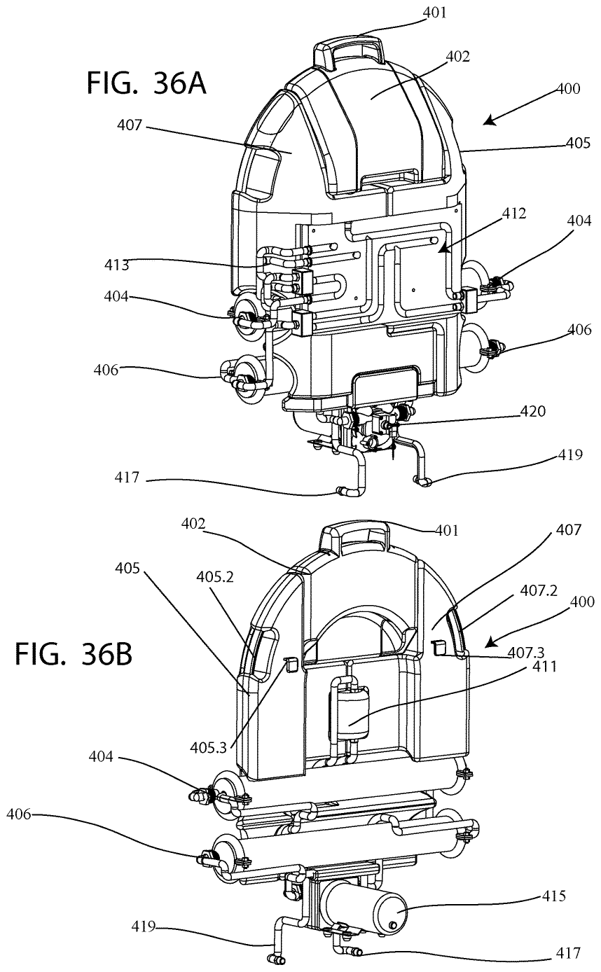

The entire modular recycling system 400 can be a modular filtration system which can be added to or removed from any device or appliance such as a washing machine (see washing machine 250) or any other appliance such as a dish washer, a sanitation system (toilet) etc. or any other system for home or industrial use which includes both clean water and grey water. FIG. 36A shows a back view of the modular recycling system 400. This view shows modular recycling system 400 which is removed from device 250 and which has purge tank 402, handle 401, tanks 405 and 407. Back plate 410 is shown removed which shows manifold 412 as well as side manifold 413. Filter housings 404 and 406 are shown as well as manifold 420 having pipes 417 and 419.

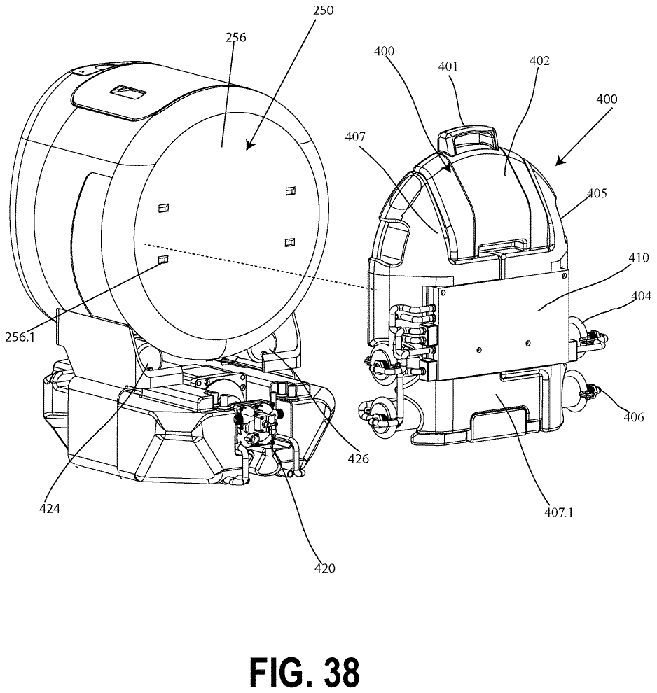

FIG. 36B shows a front view of the modular recycling system 400 which shows purge tank 402, handle 401. There is also shown grey water tank 405, as well as a clean water tank 407. Grey water tank 405 has handle 405.2 and clean water tank 407 has handle 407.2 which allow for the removal of this unit from the remainder of the device 250 when the lines such as lines or pipes 417 and 419 are disconnected. Three is also shown ozone generator 411 (See Ozone generator 202 in FIGS. 17-24) as well as filter housings 404 and 406. A pump 415 (see pumps in FIGS. 17-24) is also shown below/adjacent to filter housing 406. There are also protruding connectors 405.3, and 407.3 which allow for the connection to the back of the housing (See FIG. 38).

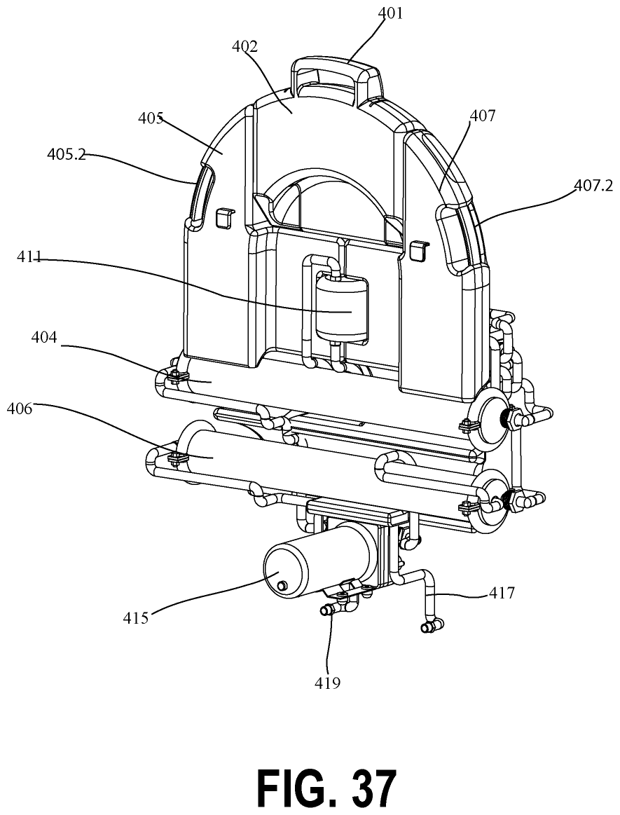

FIG. 37 shows a perspective front view of the unit 400 which includes handle 401, purge tank 402, tanks 405 and 407 having handles 405.2 and 407.2, ozone generator or 03 generator 411, filter housing 404 and 406 as well as pump 415 and lines or pipes 417 and 419.

FIG. 38 shows an exploded view of the unit 400 having purge tank 402, handle 401, side tanks 405 and 407 back plate 410, filter housings 404 and 406 as well as an additional housing portion 407.1 which can also be used as a portion of a clean water tank. This view also shows pumps 424, and 426 as well as back face 256 configured to accommodate indents 256.1 which are configured to receive protruding connectors 405.3 and 407.3.

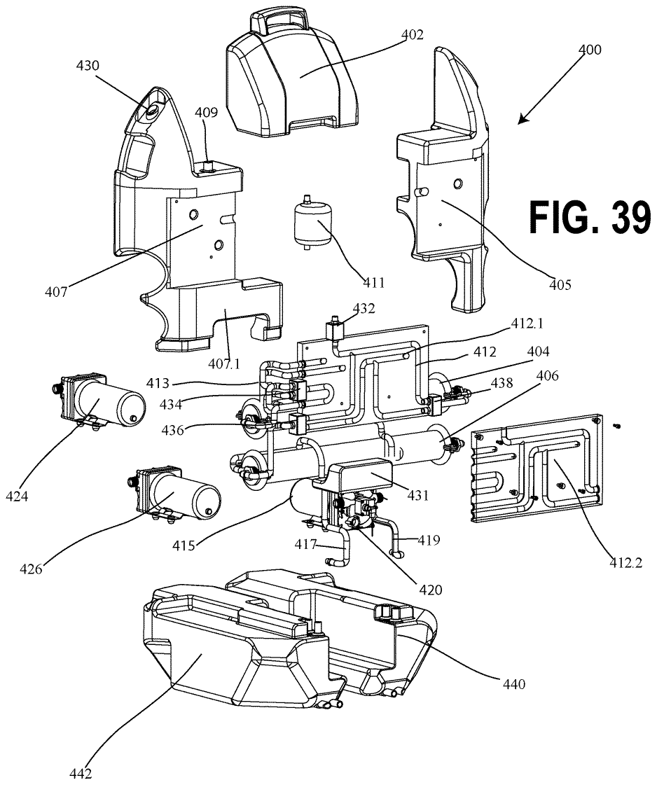

FIG. 39 shows an exploded view of the unit 400 which includes purge tank 402, tanks 405 and 407, ozone generator 411, additional tank 407.1, solenoids 432, 434, 436 and 438, filter housings 404 and 406, pumps 415, 424, 426 lower clean water tank 440, and grey water tank 442, manifolds 412, 413 as well as manifold 420. There is also shown intermediate holding tank 431 which is the same/similar to intermediate filtration tank 240 in FIGS. 17-24. The pumps 415, 424, and 426 correspond to the pumps 206, 210, 218, and 226 shown in FIGS. 17-24 etc.

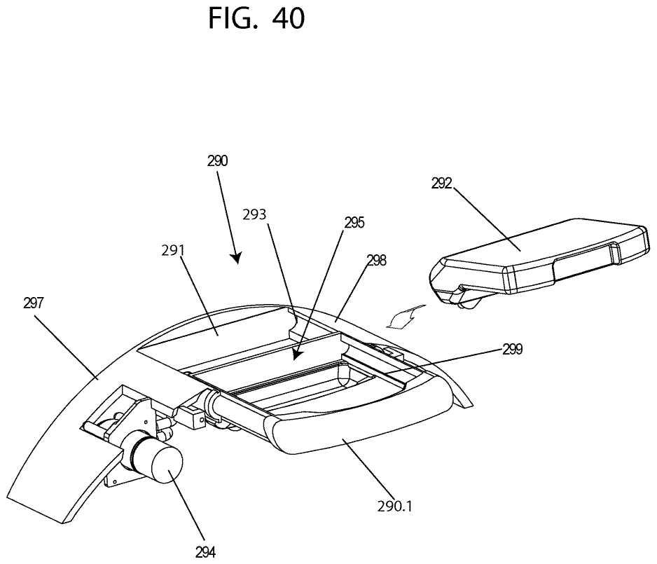

FIG. 40 shows a perspective view of the detergent container 290. Detergent container 290 includes a detergent container cartridge 292 which is configured to fit inside of the outer housing 291. A handle 290.1 is configured so that a user can slide the tray or cartridge container 295 out from housing 291, via slot 293. This allows the cartridge container 295 to slide from a closed position to an open position along slot 293. Cartridge container 295 also includes slot 299 for allowing the detergent cartridge 292 to be slid inside. The detergent container 290 includes wings 297 and 298 so that the container can fit with the outer circular or rounded housing 251. There is a detergent pump 294 positioned adjacent to wing 297.

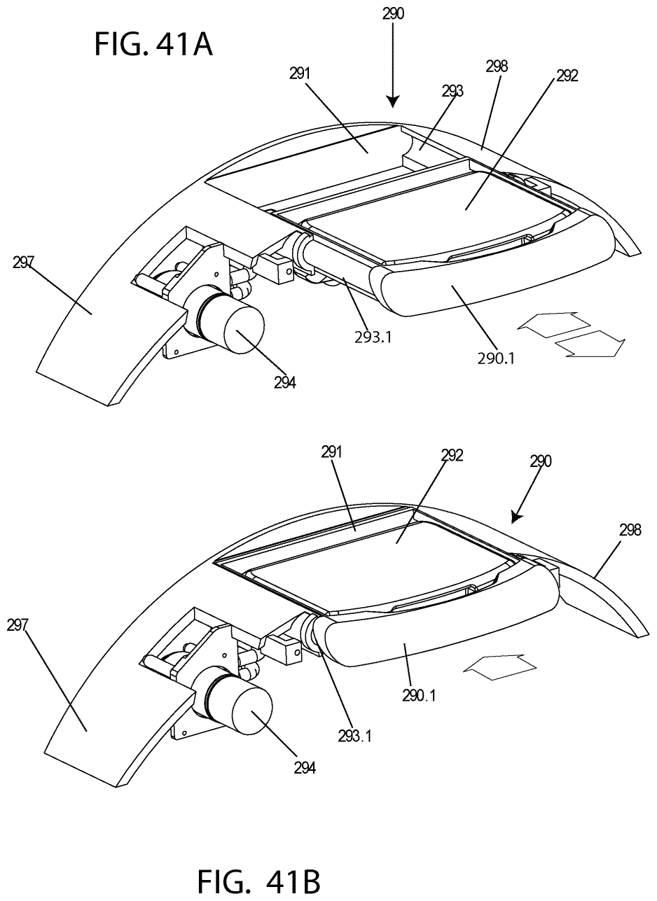

FIGS. 41A and 41B show the positions of the cartridge container 295 from an open position to slide into a closed position in the detergent container outer housing 291. The cartridge container also includes grooves 293.1 which slide within slot 293 so that a user operating handle 290.1 can push the cartridge container from a closed position to an open position and back to a closed position (See FIG. 34B). Wings 297 and 298 are shown with pump 294 shown disposed inside of wing 297.

FIG. 42 shows a back view of the detergent container 290. In this view there is shown outer housing 291, cartridge 292 which contains detergent, a handle 290.1 wings 297 and 298. There is also shown pump 294 which draws detergent from basin or collection container 294.1 into pump 294 and then through line 296 to feed the detergent into the drum.

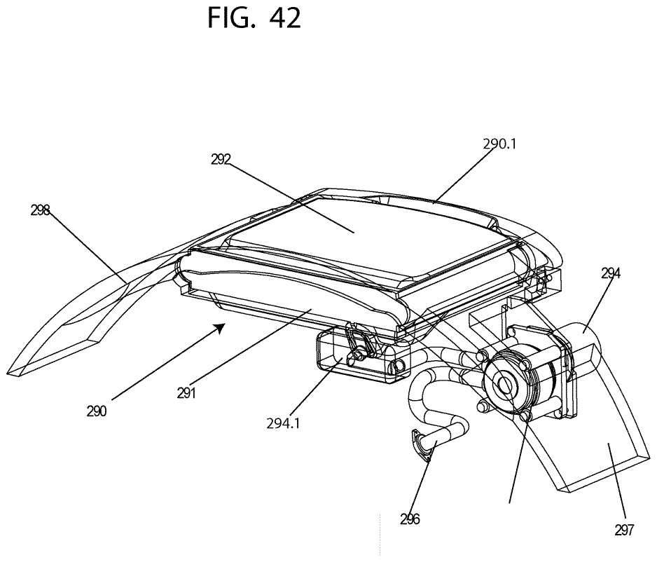

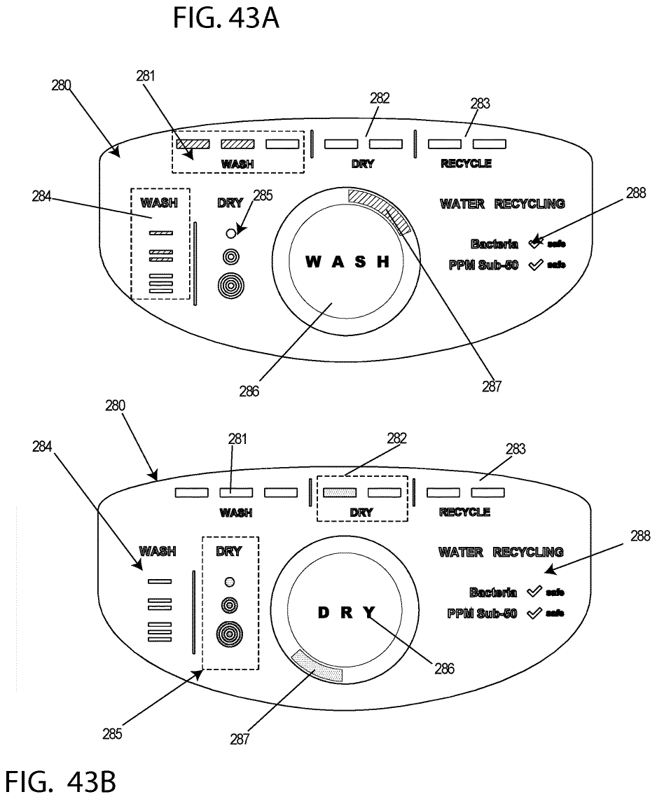

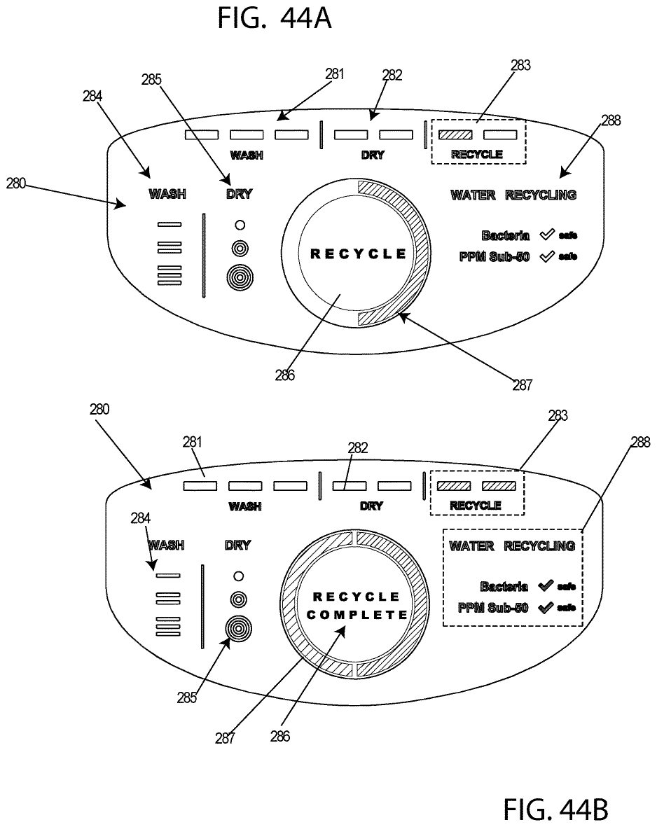

FIGS. 43A, 43B, 44A and 44B show the control panel 280 in greater detail. This control panel 280 includes a series of wash indicator lights 281, plurality of dry indicator lights 282, a plurality of recycle indicator lights 283, a wash stage indicator 284, a dry stage indicator 285, a main panel indicator 286, as well as an outer rim 287 on the main panel indicator. The main panel indicator 286 indicates the stage of the washing cycle. For example, FIG. 36A shows that the cycle is the wash cycle. FIG. 36B shows that the cycle is the dry cycle. FIG. 37A shows that the cycle is the recycle cycle, while FIG. 37B shows that the recycle cycle is complete. Thus, as shown in the control panel there is also a water recycling indicator portion which indicates that the bacteria and the particulates have been removed from the grey water and that the water in the clean water tank is clean.

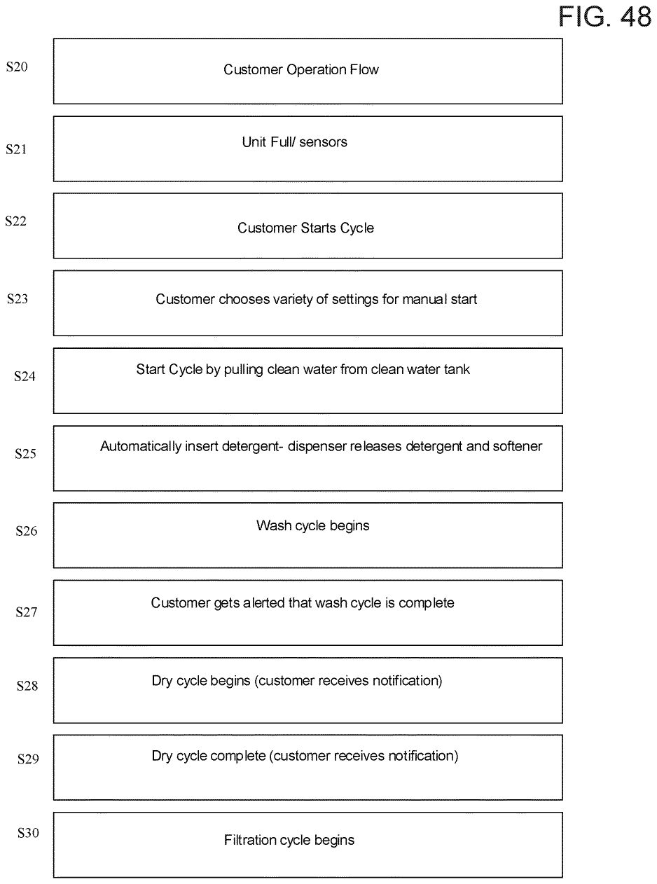

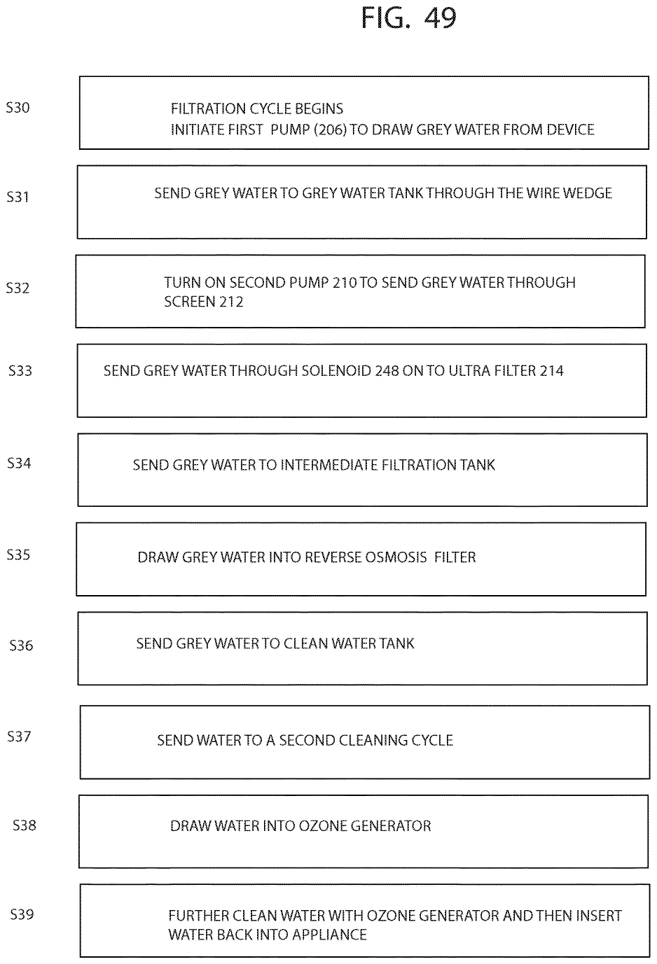

FIG. 45 is a view of the appliance controller 450. Appliance controller 450 is configured to control any suitable appliance such as appliance 250 or appliance 200 or appliance 10. Appliance controller 450 includes a motherboard 451, a microcontroller 452 (for example a microprocessor), which is configured to carry out processing or steps (see steps in FIGS. 48 and 49). A memory 454, configured to store data and programming, a transceiver 456 configured to allow for communication in either a wired or wireless mode such as tcp/ip communication, WIFI communication, cellular communication, nearfield communication, or any other sort of suitable communication. I/O ports 460 are configured for direct communication to other directly connected devices such as any one of the pumps, solenoids, heaters, sensors, or other external devices. There is also a touchscreen 462 which is similar to or the same as touch screen 280 which allows for direct input from a user as well as indicate a state of the appliance. There is a power supply 468 wherein these components are coupled to mother board 451 and powered by power supply 468. In addition, coupled to and controlled by the controller are a plurality of pumps such as pumps 472, 474, 476, and 478 which are in communication with motherboard and/or microcontroller 452 via the I/O ports 460 or via the transceiver 456. These pumps 472, 474, 476, and 478 correspond at least to pumps 206, 210, 218, and 226 discussed above. Solenoids 464, 466, 468, and 470 correspond to solenoids 242, 244, 246 and 248 discussed above. These solenoids are also in communication with motherboard 451 and controlled by microcontroller 452 as well. There are also a plurality of level sensors 480, 482, 484, and 486 which can be placed inside of any one of the tanks such as inside of the automated appliance, the grey water tank 208, the intermediate filtration tank 240, the clean water tank 220, and the removable purge tank 222 discussed above as well as any other suitable tank in the system. These level sensors can be used to detect the level of fluid in each one of these tanks and if the fluid level gets too high signals can be sent to motherboard 451 and then on to microcontroller 452 which can be configured to selectively operate a pump or a solenoid to drain a suitable tank or move fluid from one tank to another tank such as from grey water tank 208 to intermediate filtration tank 240, or from intermediate filtration tank to clean water tank 220 or from grey water tank 208 to removable purge tank 222. Microcontroller 452 can be used to also control O3 generator 488 which is similar to or the same as O3 generator 202 described above. In addition, microcontroller 452 can be used to control heater 490, heat pump 492, an ultraviolet device for ultraviolet rays projecting on the water or the air inside of the appliance. Furthermore, microcontroller 452 can also be configured to control dehumidifier 496 which is the same or similar to the dehumidifier 407 described above. There is also an optional light which can be disposed on the appliance (See light 274.1 in FIG. 25) wherein this light can be used to indicate the state of the machine, such as whether the recycling cycle has been completed. This light 497 is controlled by micro controller 452 and can be a multicolored LED light to indicate a certain state of the appliance. In addition, microcontroller 452 can be in communication with other electronic components listed below to further control the appliance.

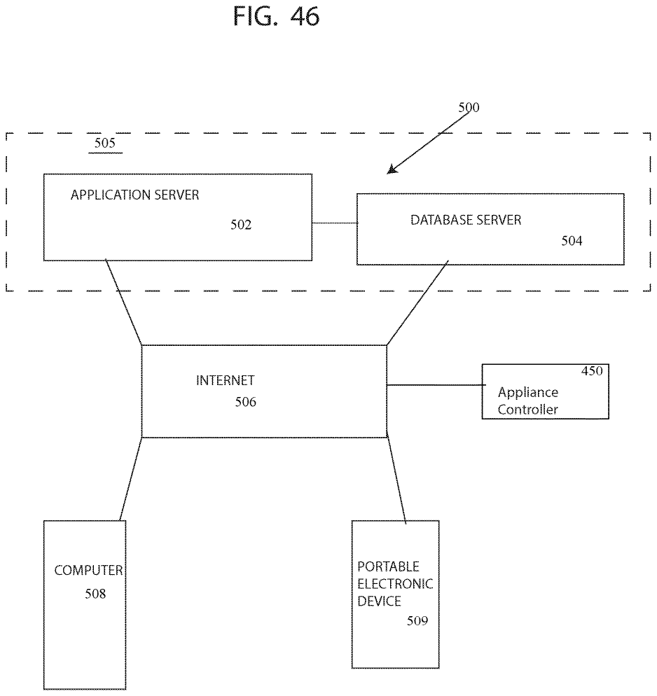

FIG. 46 is a view of a computer network which is configured to control either remotely or on site a washing machine disclosed above. For example, in this view, there is shown the network 500 having an application server 502, a database server 504 wherein both can be integrated into a single server 505. These servers 502, 504 and/or combined server 505 are in communication with a computer network such as the internet 506. In addition, in communication with the internet are one or more computer(s) 508, one or more portable electronic device(s) 509 as well as one or more washer(s) such as any suitable appliance controller 450. With this design, any one of the servers 502, 504, 505 can be used to control an appliance controller 450.

Alternatively, a computer 508 can be used to control appliance controller 450, as well as portable electronic device 509 can be used to directly control any one of washer(s) appliance controller 450.

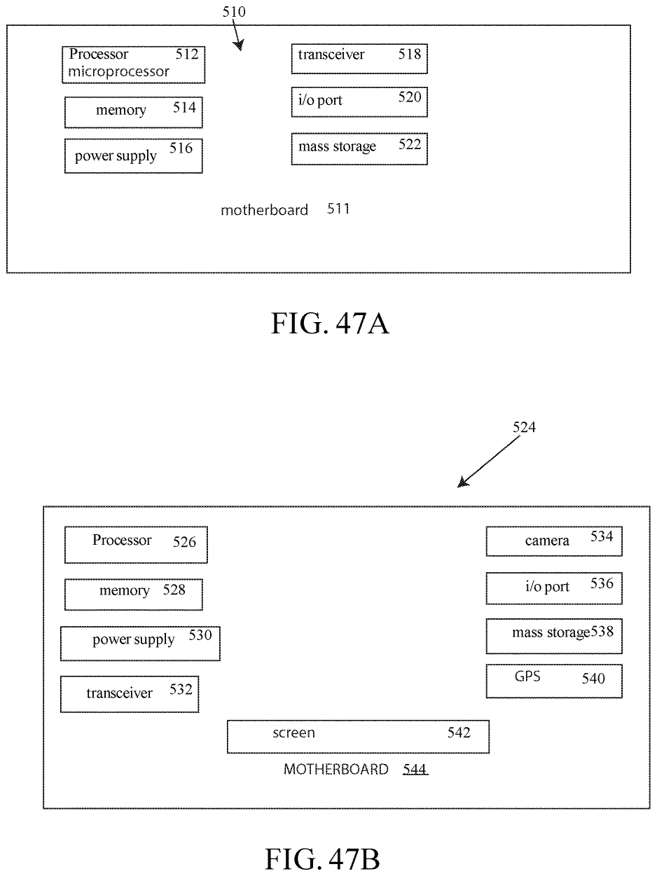

An example of the schematic diagram of the server(s) is shown in FIG. 47A. For example, server(s) 502, 504, 505 can be represented by server 510 having a motherboard 511, a processor/microprocessor 512 a memory 514, a power supply 516, a transceiver 518, an I/0 port 520, and a mass storage 522. The components 512-522 are powered by the power supply 516 on the motherboard 511. These devices are in communication with each other through at least one bus/communication line on the motherboard.

FIG. 47B is a view of at least one computer 508 and/or portable electronic device 509 represented by device 524. This device includes a motherboard 544, a processor/microprocessor 526, a memory 528, a power supply 530, a transceiver 532, a camera 534, an i/o port 536, a mass storage device 538, a GPS, 540 and a screen 542. This device can communicate through the internet 506 to communicate with application server 502, database server 504, or to combined server 505 as well as to computer or portable electronic device 509, and to another portable electronic device as well as appliance controller 450.

FIG. 48 is a flow chart for controlling the customer operations flow. For example, the process starts in step S20 wherein the customer operation flow is started. Next, in step S21 the system checks the unit sensors. Next, in step S22 the customer starts the cycle. Next, in step S23 the customer chooses a variety of settings for a manual start. Next, in step S24 the system starts the cycle by pulling clean water from the clean water tank. Next, in step S25 the system automatically inserts detergent such that the dispenser releases the detergent and/or softener. Next, in step S26 the wash cycle begins. Next, in step S27 the customer is alerted that the wash cycle is complete. This alert can be in the form of an audible alert or a lighting alert on the control panel. Next, in step S28 the drying cycle begins wherein the customer also receives a notification that the drying cycle has begun. Next, in step S29 the system alerts the user that the dry cycle is complete. Next, in step S30 the filtration cycle begins. This filtration cycle can include filtering steps shown in

FIG. 49 shows the flow chart for the filtration cycle. For example, this filtration cycle starts by starting the first pump to draw grey water from the appliance. Next, in step S31 the grey water is drawn through a wire wedge to remove particulates. Next, in step S32 a second pump is turned to send grey water into a second screen. Next, in step S33 the grey water is sent through solenoid 248 and then on to ultra filter 214.

Next, in step S34 the third pump 218 is turned on to draw the grey water through permeate line 230 to intermediate filtration tank 240. Next, in step S35 the grey water is drawn into reverse osmosis filter 216. Next, in step S36 the grey water is drawn through permeate line 230 into clean water tank 220 via third pump 218. Next, in step S37 the clean or existing grey water can be recycled for a second cleaning cycle by opening any one of solenoids 248, 242, or 244 to send the fluid back into grey water tank 208. Next, in step S38 the fourth pump 226 can be activated to draw fluid from the clean water tank 220 through the fourth pump 226 into the ozone generator 202. In step S39, the water can be further cleansed by the ozone generator 202 before it is then sent back into automated appliance 200 for further use.

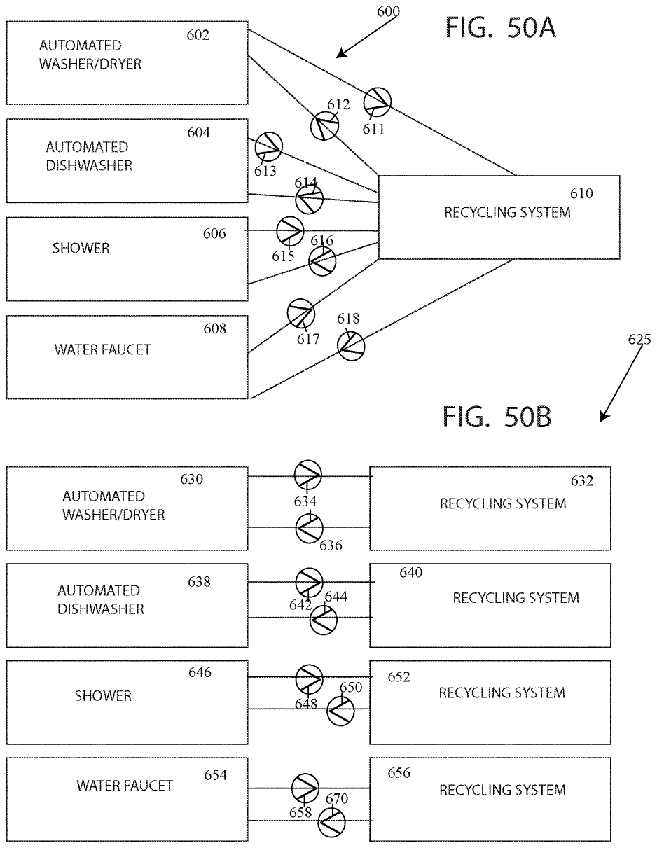

FIG. 50A is a schematic block diagram of multiple devices utilizing a single recycling system with connections in parallel to each other. For example, there is shown an automated washer/dryer unit 602 which is connected to a recycling system 610 via an input line 611 having a pump. Grey water from the washer dryer unit 602 then flows through the input line 611 as being drawn by the associated pump. Once the water is recycled it is returned to device 602 via outflow line 612. There is also shown an automated dishwasher 604 which is in communication with recycling system 610.

There is an input line 613 having a pump which pumps grey water from the dishwasher 604 into the recycling system 610. There is an outflow line 614 which has a pump which pumps clean water from the recycling system 610 into back into the appliance such as the automated dishwasher 604. There is a shower 606 which has an input line 615 having a pump into recycling system 610. When the grey water from the shower is cleaned in the recycling system 610 it is returned via outflow line 616 having a pump wherein this pump then pumps the clean water back to the shower. There is also a water faucet 608 having an input line 617 having a pump for pumping the grey water into the recycling system 610. When the grey water from the water faucet is cleaned the pump in the outflow line 618 then pumps this clean water back to the water faucet. In each of these systems the recycling system can be the same or similar to the recycling systems shown in FIGS. 1-24.

In addition, as shown in FIG. 50B, there are multiple appliances each connected to their own recycling system. For example, there is an automated washer/dryer 630 having an input line 634 having a pump for pumping grey water into the recycling system 632. Once the grey water is cleaned it is then pumped through outflow line 636 having a pump to pump this clean water back into the automated washer dryer 630. Similarly, there is an automated dishwasher 638 in communication with a recycling system 640 having an input line 644 having a pump for pumping grey water into this recycling system. There is also an outflow line having a pump for pumping this clean water back into the automated dishwasher 638. There is also a shower 646 having an input line 648 which feeds into recycling system 652. Once the water is cleaned from the recycling system 652, it flows through outflow line having a pump back to the shower 646. Furthermore, there is a water faucet having an outflow line 658 which feeds into recycling system 656. Once the water is cleaned it flows through outflow line via a pump 658 back into water faucet 654. The recycling systems 632, 640, 652, and 656 can be any one of the recycling systems shown in FIGS. 1-24 such that these recycling systems can be adapted to any suitable appliance.

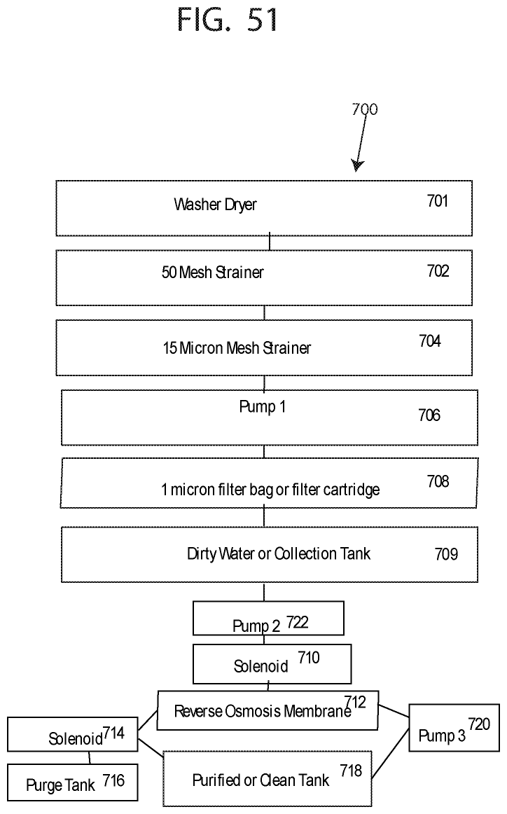

FIG. 51 is another embodiment, which generally shows that grey water is generated during a laundry cycle. This view shows another system 700 which includes a washer/dryer 700 which includes a 50-mesh strainer 702. In at least one embodiment the strainer could be a 50-150 mesh inline strainer. Adjacent to the 50-mesh strainer is a 15-micron mesh strainer 704. Pump 1 (706) draws water from the washer dryer dirty water tank (701) through strainers 702 and 704. This water then flows through the 1-micron filter bag 708 and onto the dirty water collection tank 709. Once in the dirty water tank 709, water can be pumped to second pump 722. The water flow controlled through solenoid 710. Water flows through solenoid and on to reverse osmosis membrane 712. Water can then flow through solenoid 714 to purge tank 716. Pump 3 or the third pump 720 pulls water from the purified or clean tank 718 into the reverse osmosis membrane 712 which then selectively sends the water either back to the purified or clean tank 718 or to the purge tank 716 based upon the three-way solenoid 714.

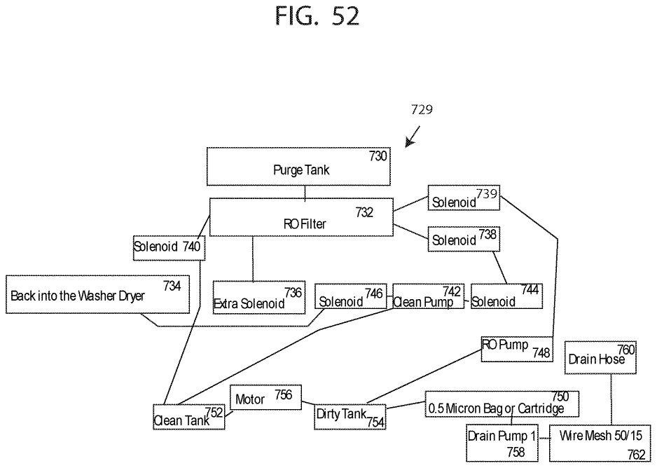

FIG. 52 shows embodiment 729 with a purge tank 730 linked to a reverse osmosis filter 732. The RO filter connects to solenoids 736, 738, 739, and 740. The extra solenoid 736 is for allowing a purge of fluid from the reverse osmosis filter 732.

Water moves from tank 752 through motor 756 to wash clothes. The water flows into dirty tank 754. This water then flows into a 0.5-micron bag or cartridge 750 which is drawn into drain pump 758. This water then flows through wire mesh 50/15 762. Water can then flow out from drain hose 760. Water from dirty tank 754 can instead be sent via RO pump 748, through solenoid 739, and returned to the RO filter 732. Once water has gone through the filters and reverse osmosis filter 732, it is pulled from clean pump 742 by solenoid 740 into clean tank 752 and then cycles back to clean pump 742. Solenoid 744 controls or blocks flow through clean pump 742. Solenoid 744 can control whether the water flows through solenoid 744 and onto solenoid 738 and then back into RO filter 732. Water purified by the RO filter can be pumped from clean pump 742 through solenoid 746 to washer/dryer 734. A controller, such as controller 450 in FIG., can manage all these components. 45.

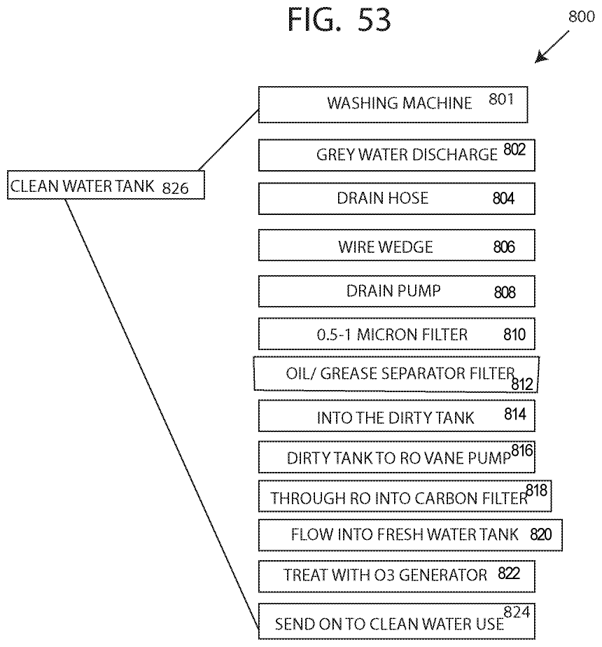

FIG. 53 is a flow chart for the process for recycling water in a washing machine or other appliance. For example, in this process 800 the process starts with water entering an appliance such as a washing machine 801 wherein the washing machine 801 uses water and then sends it on to the grey water discharge 802. Next, in the grey water flows through drain hose 804 and then on to wire wedge 806. In at least one embodiment, the wire wedge is a 50-150 mesh inline wire wedge or strainer. The water is then drawn into drain pump 808. Next, the water is directed into sediment filter 810. The filter is in the form of a 0.5 to 1 micron filter cartridge or bag 810. Next the water can flow into the oil/grease separator filter 812. Once the oil and grease has been removed, it flows into the dirty tank 814. Next the water flows from the dirty tank to RO vane pump 816. Next, the water flows into a carbon filter and then into the freshwater tank 820. Next, this water is treated with the O3 generator 822. Next, the water can be sent onto the clean water tank in step 824 to clean water tank 826. This clean water can then be recycled to the washing machine 801. Thus, this alternative system is a comprehensive cleaning system for cleaning water that cycles through a washing machine.

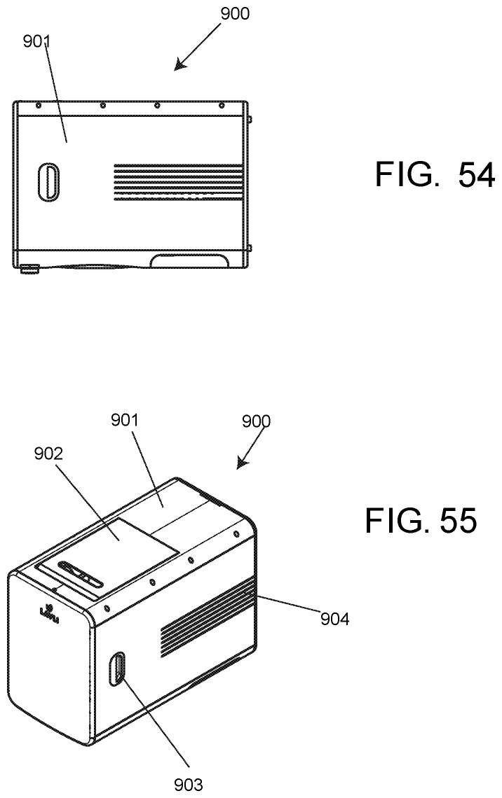

FIG. 54 is a side view of another embodiment 900, which shows a housing 901. FIG. 55 is a back perspective view of the embodiment of FIG. 55. This embodiment 900 includes a housing 901, a back panel 902, a side vent 904, as well as handles 903.

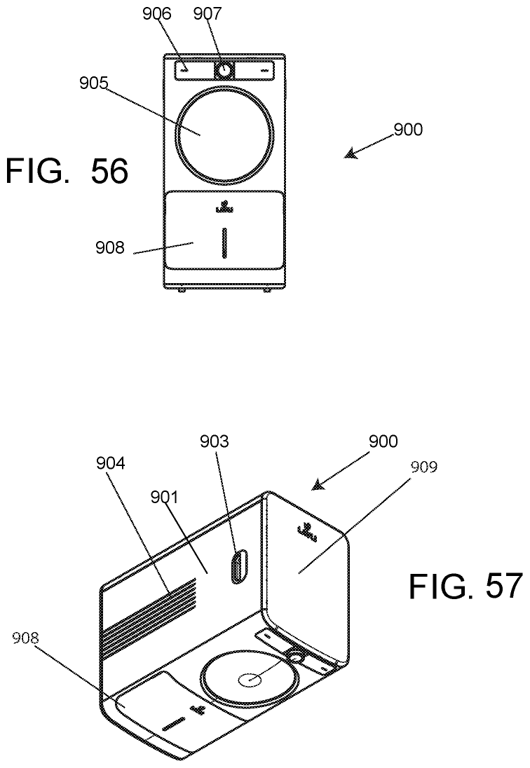

FIG. 56 is a front view of the embodiment 900, showing a control panel 906, a dial 907, a front-loading opening 905, and a removable panel or door 908. FIG. 57 is a front-top left side perspective view of the embodiment 900, which shows body or housing 901, a vent 904, a tray or cover 908, a handle 903, and a top 909.

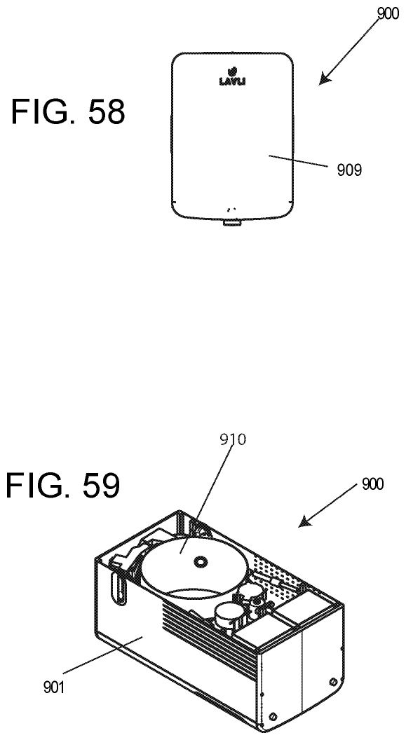

FIG. 58 shows a top view of the embodiment 900, which shows a top 909. FIG. 59 is a cross-sectional view which shows a view of the drum body 910 as well as the housing 901.

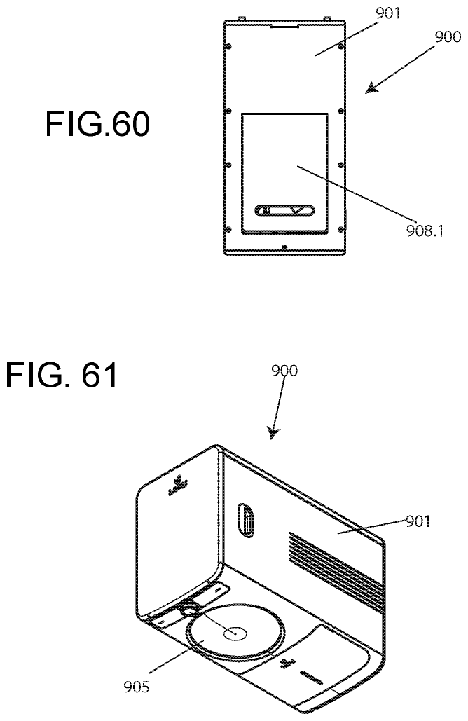

FIG. 60 shows a back view of the embodiment 900, which shows a back panel 908.1, disposed in housing 901. FIG. 61 is a front side perspective view of an embodiment 900, which has a front loading opening 905 as well as a body section 901.

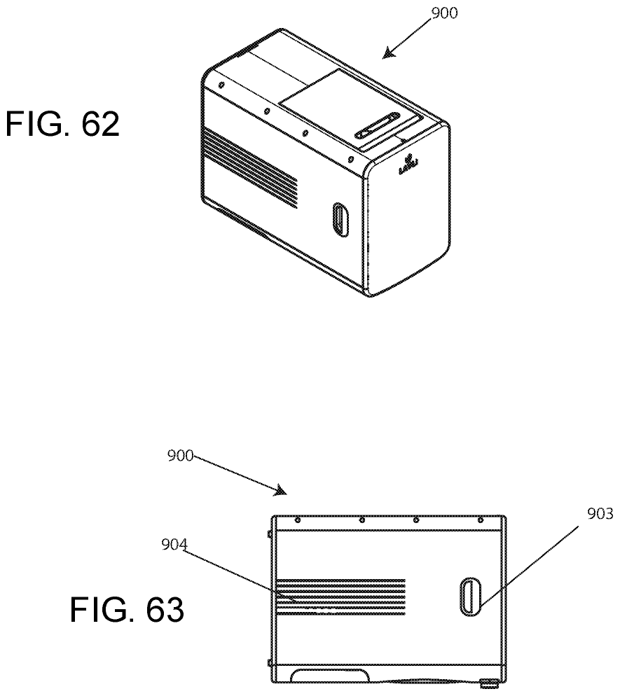

FIG. 62 is a back perspective view of the embodiment 900. FIG. 63 is a side view of the embodiment 900 with the opposite side being identical. This view shows handle 903 and vent 904.

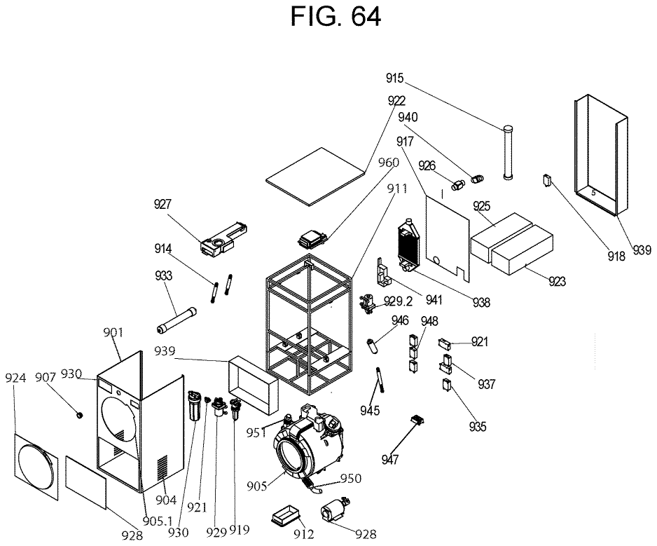

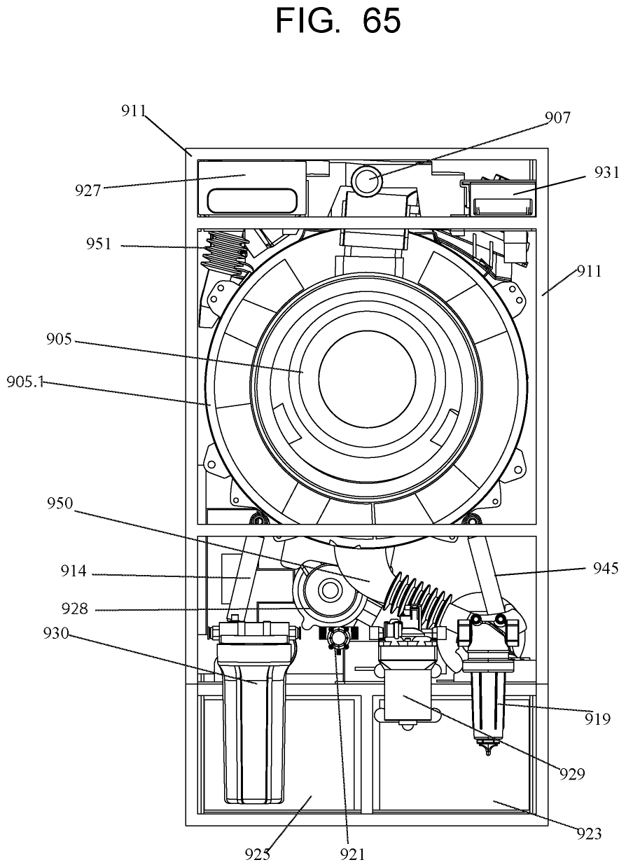

FIG. 64 shows an exploded view of the design, which includes the housing 901, which can be coupled around a frame, such as frame 911. Coupled to the housing or body 901 is a front panel 924 which fits in a round front opening 905.1 in housing 901. There is also a front panel 908, which fits into housing 901 and which can also be removed from housing 901 to allow for access to components that fit inside the device. In addition, a dial 907 can be inserted into a front housing 901 as well. Housing 901 also includes side panels, including vents 904. There are also a plurality of filters and other components, including a cartridge filter 930, a water flow sensor 921, and a Pentair pump 929. An inline strainer 919, which is disposed adjacent to the pump 929 which can be a Pentair@ pump. These components are disposed inside of a front box compartment 939. A grey water filter 933, is configured to remove contaminants from the grey water, including plastics, toxins, phosphates, and other pollutants. This filter 933 is disposed adjacent to the three filters and/or pumps, including the inline strainer 919, the Pentair pump 929, and the cartridge filter 930. The inline strainer 919 is configured to remove larger particles. The cartridge filter 930 is configured to remove the smaller particles, while the grey water filter 933 is configured to filter the water further. The final cleaning portion is done through the reverse osmosis filter 915. The reverse osmosis filter has a membrane that separates water from other chemicals and removes dissolved biologicals and bacteria.

Drum 905 is configured to be positioned in a center position in this housing and is configured to have a fluid intake 951 and an outflow 950. A purge tank assembly is configured to receive the purge water from the drum after the washing cycle in the drum 905. There are a series of dampers 914 and 945 disposed on either side of the drum 905. Positioned above the drum 905 is a purge tank assembly 927. This purge tank assembly is configured to take the purged tank water from the drum after a washing cycle and then eventually distribute this water to the other remaining tanks 923, and 925.

A carbonator pump 928 is positioned adjacent to and below drum 905. An additional Pentair pump 929.2, is disposed behind drum 905 as well. These Pentair pumps can be variable speed pumps which selectively fill or drain the drum 905. Power regulation occurs through a series of electronic components, such as an electronic board assembly, including a 5v board assembly 935, and a 120V board assembly. board assembly 921 and a 12v board assembly 937. There is also a motor board assembly 948 which is configured to drive the motor on drum 905. The motor board assembly 948 is driven by the motor controller 941. Positioned adjacent to the motor controller 941 is a condenser 938. Condenser 938 is configured to remove moisture or water from the air. The water that is removed would then be sent back to one of the two water tanks such as to tank 923 or tank 925. An OmniPure® or carbon inline filter 946 is configured to receive water from the drum 905 and then deliver this water back to one of the water tanks 923 and 925. An inline pipe fan 926 and 940 are configured to drive the air through the pipes, such as pipe 951, and into the drum. This air flowing into the drum 905 then creates a dryer mechanism which then has forced air such as heated forced air into the dryer. The pipe fan can also aid in the evaporation of water from the air when the dryer is sent to condenser 938.

In the back section, there is a back plate 917 configured to seal the back of the component. Disposed towards the back is an ozone generator 918, which is positioned adjacent to a reverse osmosis filter 915. Ozone generator is configured to bubble or inject ozone into the water where it acts as an oxidizer breaking down contaminants and disinfecting the water. A top plate 922 is also configured to be positioned on top of the frame 911. In addition, a back cover 939 is configured to close out the back end of the device.

FIG. 65 is a front view of the embodiment 900, showing a frame 911, a dial 907, and a purge tank assembly 927 configured to house the purge tank. The dial is configured to set the controls on the device for both the washing cycle and the drying cycle. Feed tube 951 feeds water into drum 905. Drum 905 includes a drum body 905.1 which forms the outer cylindrical body for the drum. There is also an outflow tube 950, which allows fluid to flow from the drum 905. A plurality of dampers 914 and 945 are shown on either side of drum 905.

Carbonator pump 928 is positioned below drum 905. Carbonator pump 928 is configured to carbonate the water, making it essentially activated water, allowing clothes to be cleaned with little or no detergent. Cartridge filter 930, Pentair pump 929, and inline strainer 919 are positioned in a front portion of the unit and positioned behind panel 908. A controller board 931 is also shown positioned on the top portion of frame 911. This controller board is configured to control the display and the dial 907 on the unit.

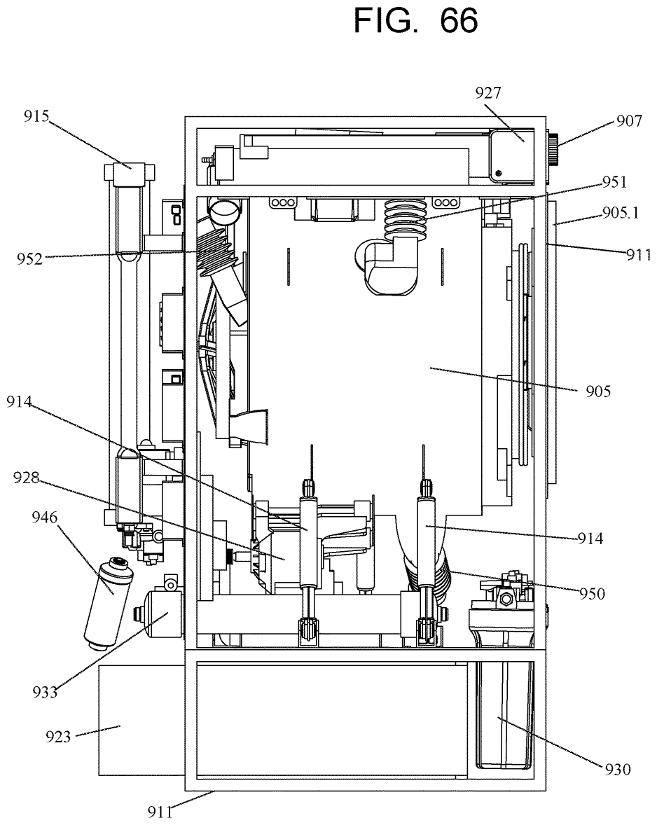

FIG. 66 is a side view of the embodiment 900, showing the purge tank assembly 927. Feed tube 951 sits adjacent to drum 905. A plurality of dampers 914 are configured to support the drum both vertically and horizontally and to dampen the movement and vibrations in the drum when it is rotating. The drum 905 is configured to rotate when there is water and washing materials in the drum to wash the clothes. The drum 905 is also configured to rotate to dry the clothes as well, after the clothes have been washed.

Reverse osmosis filter 915, is positioned towards a back portion of the machine. Reverse osmosis filter 915 is configured to cleanse the water of the impurities so that once the water leaves the drum, the dirt and other soiled materials can first flow into the purge tank assembly 927 and then on to the reverse osmosis filter 915. Grey water filter 933 can be made from Wavebrite® and is positioned at a bottom portion of the machine. This filter is a grey water filter and is configured to filter out the impurities in the water. There is also a purge tank assembly 927, which is shown adjacent to dial 907. Essentially once a water cycle is finished, the water flows from the drum to the purge tank and then on to the reverse osmosis filter 915. This water then flows on to the grey water filter 933. The water can then flow back to either the purge tank assembly 927 or on to one of the water tanks 923 or 925. Outflow tube 950, and two inflow tubes 951 and 952 are coupled to drum 905. A plurality of tanks 923 and 925 (not shown) are positioned on the bottom of the frame 911. A cartridge filter 930 is positioned in front of the device 900 below the drum 905. Carbonator pump 928 is shown below drum 905 as well. An Omnipure® or carbon inline filter 946 is positioned towards the back of the device. This filter is a carbon filter and is configured to remove biological or carbon based particles from the water.

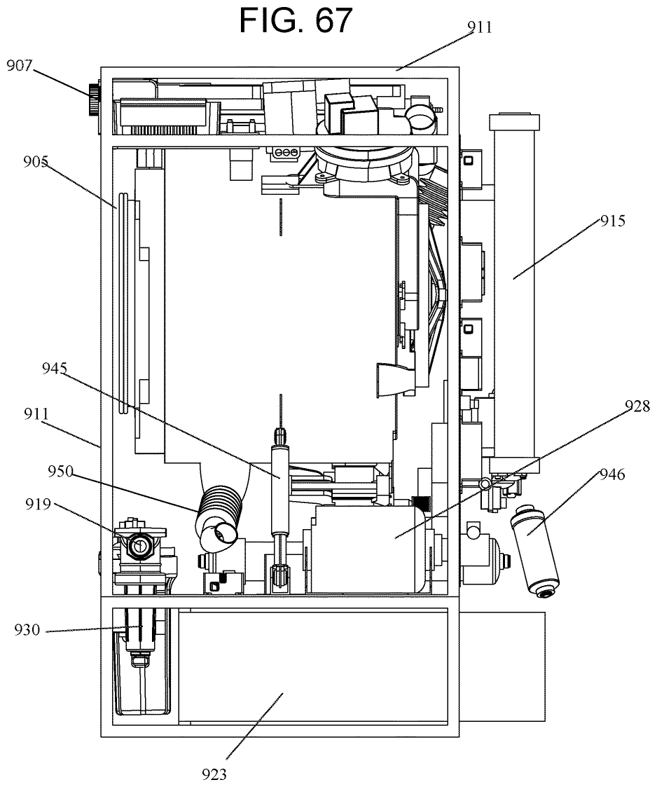

FIG. 67 is an opposite side view of the device with the cover removed. In this view there is shown frame 911 which houses the components of the device. Drum 905 is positioned in front of reverse osmosis filter 915. Below but adjacent is Omnipure @ inline filter 946. Carbonator pump 928 is also shown adjacent to filter 915. The carbonator pump is positioned below the drum 905. The carbonator pump takes water from one of the water tanks 923 or 925 and then injects it into drum 905 after a carbonating treatment. In front of the drum is the dial 907. There is also the inline strainer 919 as well as the cartridge filter 930. A damper 945 is also shown coupled to the drum. This damper 945, as well as damper 914, is configured to support both the vertical and horizontal dimensions.

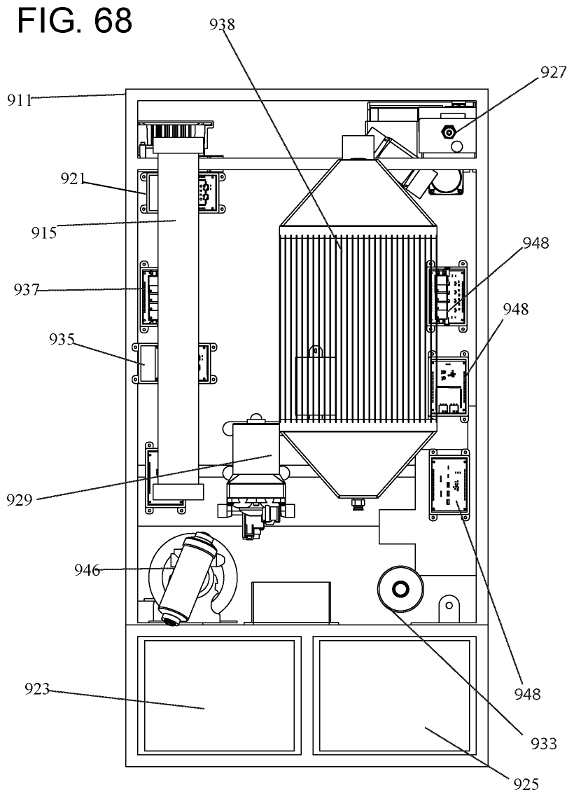

FIG. 68 shows a back view of the device, which shows frame 911 as well as condenser 938. Positioned in front of condenser 938 is purge tank assembly 927. A plurality of motor controller boards 948 are shown adjacent to the condenser unit 938. A reverse osmosis filter 915 is shown adjacent to the different board assemblies, including the 120 v. AC board assembly 921, the 12v board assembly 937, and the 5v board assembly 935. Grey water filter 933 is also shown, as well as the inline filter 946. Water tanks 923 and 925 are shown extending towards the back of the device as well. Pentair pump 929 is shown adjacent to the condenser.

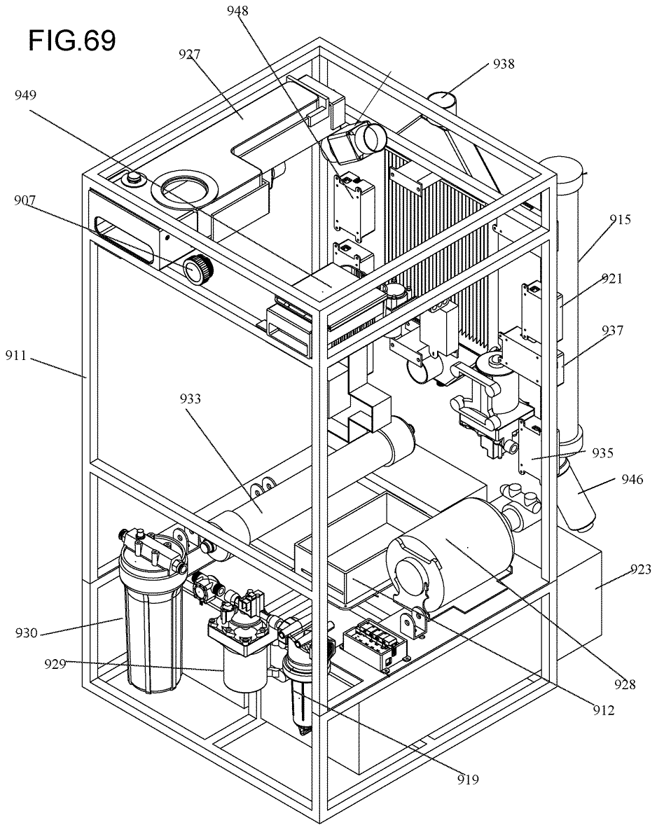

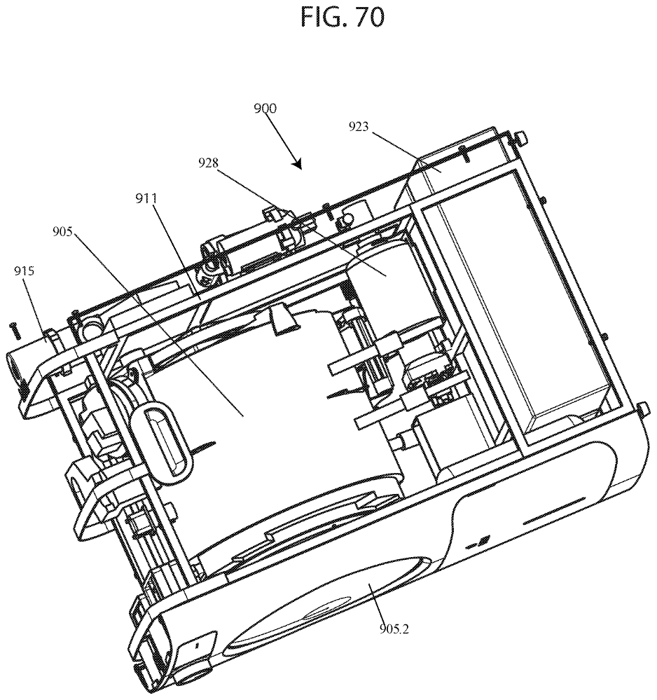

FIG. 69 is a perspective view of the device, which shows frame 911. This view shows dial 907, cartridge filter 930, Pentair pump 929 and inline strainer 919 as well. A carbonator pump 928 is positioned towards the bottom position of frame 911. Grey water filter 933 is shown opposite the carbonator pump 928. Purge tank assembly 927 is positioned towards the top of the frame. There is a controller 949 which is configured to control the interface board which has the dial 907 as well. Towards the back of the frame is a motor board assembly 948 which controls the motor of the drum 905. A condenser 938 is positioned towards the back of the frame 911. Condenser 938 is configured to draw the water out of the air during the drying stage. Positioned adjacent to the condenser 938 is a reverse osmosis filter 915. In addition, positioned adjacent to the reverse osmosis filter 915 is the 120 v AC board assembly 921, the 12V board assembly 937, and the 5V board assembly 935. Inline filter 946 can be a carbon filter and is positioned below the reverse osmosis filter 915. A water tanks 923 and 925 is shown positioned at the bottom of the frame 911.

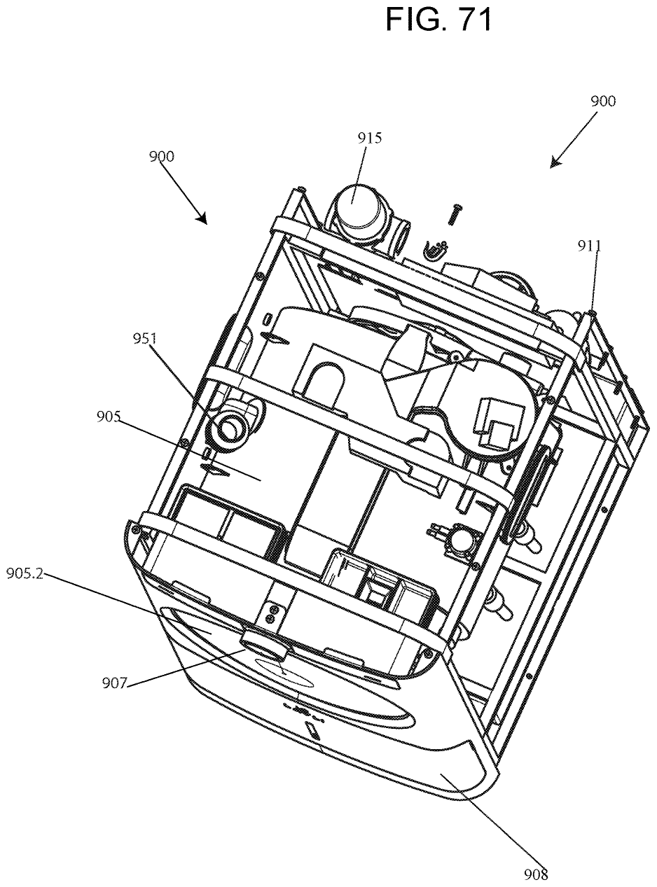

FIG. 70 is a side view of the embodiment 900, showing drum 905, frame 911, reverse osmosis filter 915, carbonator pump 928, and water tank 923. A front door 905.2 is shown closed, but it can selectively grant access to drum 905.

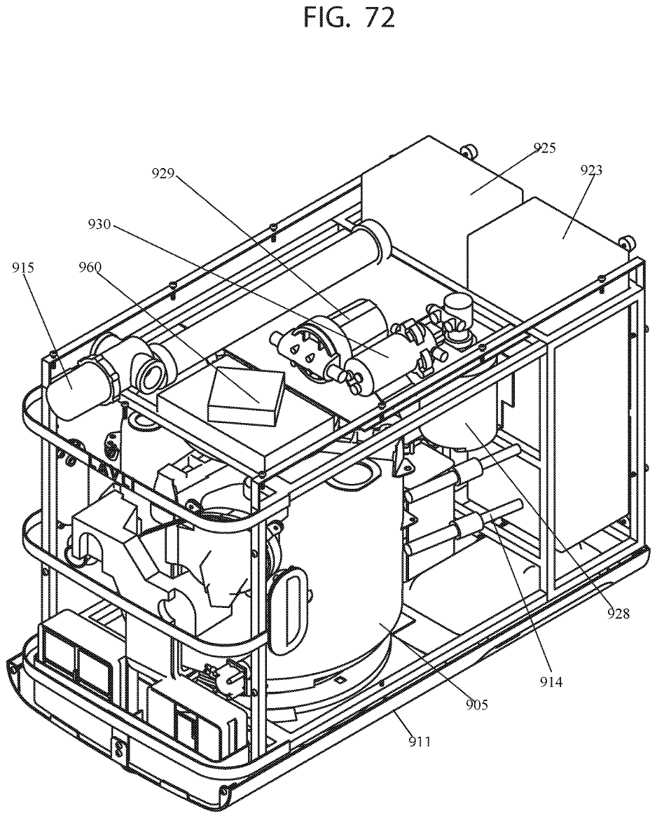

FIG. 71 is a top view of the embodiment 900, which shows frame 911. A drum 905 is shown extending substantially from a back section to a front section of the frame 911. On the front face is a dial 907. The front door for the drum 905.2 is positioned above panel door 908. A feed pipe 951 is positioned above drum 905 as well. Reverse osmosis filter 915 is shown positioned towards the back of the device as well.

FIG. 72 is a perspective back view of the embodiment 900. Frame 911 supports drum 905. Drum 905 is supported by dampers 914. Carbonator pump 928 is positioned above water tanks 923 and 925. Reverse osmosis filter 915 is positioned along the back section of the frame 911. In this embodiment, a Pentair pump 929 and a cartridge filter 930 are shown. There is also a damping plate 960, which is positioned on this back face as well.

Thus, a compact design for a combined washer-dryer system is created that selectively grants access to components, such as pumps and filters, that may need to be replaced regularly.

Accordingly, while at least one embodiment of the present invention have been shown and described, it is to be understood that many changes and modifications may be made thereunto without departing from the spirit and scope of the invention as defined in the appended claims.

1. An automated appliance with water recycling comprising:
at least one housing (12, 251);
at least one appliance (10) disposed inside of said housing (12); and
at least one recycling system (30, 40, 50, 60, 70, 80, 90) disposed in said housing, wherein the recycling system comprises:
at least one first tank (24, 208) downstream from said at least one appliance for receiving water used by the appliance;
at least one reverse osmosis filter (70, 216) disposed in said at least one housing and for receiving water from said at least one first tank;
at least one clean water tank (220) coupled to the output of said at least one reverse osmosis filter;
at least one filter (70, 212, 214, 216) disposed between said at least one first tank and said at least one clean water tank;
at least one ozone generator (40, 202) disposed between said first tank (24, 208) and said at least one clean water tank (220);
wherein said at least one recycling system is configured to recycle water used by the appliance so that the water used by the appliance is sent to said at least one clean water tank to be reused in further cycles by the appliance.

2. The appliance as in claim 1, wherein said at least one filter comprises an ultrafilter (214).

3. The appliance as in claim 1, wherein said housing comprises an upper housing (251) and a lower housing (301), and a removable purge tank (324), wherein said removable purge tank (324) is removable from said lower housing (301).

4. The appliance as in claim 1, further comprising a purge tank (402) wherein said housing (251) comprises a back housing (400), wherein said purge tank (402) is a removable purge tank disposed in said back housing (400).

5. The appliance as in claim 1, wherein said at least one filter (216) is configured to filter out particulates which are greater than 0.0001 microns.

6. The appliance as in claim 5, further comprising at least one removable purge tank (222).

7. The appliance as in claim 6, further comprising at least one lint module (224) disposed adjacent to said at least one removable purge tank (222).

8. The appliance as in claim 1, wherein the appliance is a washing machine (250) configured to wash clothes.

9. The appliance as in claim 1, further comprising at least one dehumidifier (30, 207) configured to draw fluids from ambient air and to then input said fluids into said at least one grey water tank (208).

10. The appliance as in claim 13, wherein said at least one dehumidifier (30, 207) is disposed in said housing.

11. The appliance as in claim 13, wherein said at least one dehumidifier (207) is disposed external to said housing.

12. The appliance as in claim 1, further comprising at least one removable water replenishment tank (211) which is configured to feed water into said at least one grey water tank (208).

13. The appliance as in claim 1, further comprising at least one microcontroller (452), said at least one microcontroller (452) configured to control components in said at least one appliance to control a wash cycle, a dry cycle and a recycling cycle.

14. The appliance as in claim 12, further comprising at least one solenoid (464) and at least one pump (472), wherein said at least one microcontroller (452) is configured to control said at least one pump and said at least one solenoid to control said at least one wash cycle, said at least one dry cycle and said at least one recycling cycle.

15. The appliance as in claim 12, further comprising at least one indicator light (274.1 281, 282, 283, 497), wherein said at least one indicator light is configured to indicate when the appliance is in at least one wash cycle (281), said at least one dry cycle (282) and in said at least one recycling cycle (283).

16. The appliance as in claim 14, further comprising at least one touchscreen (462, 280) wherein said at least one touchscreen (462, 280) has an indicator (288) that is configured to indicate when said at least one recycling cycle has been completed.

17. The appliance as in claim 1, further comprising at least one three-way valve (244) coupled between said reverse osmosis filter (70, 216) said clean water tank (220) and said purge tank (402), said three-way valve (244) for selectively allowing fluid to flow from said reverse osmosis filter (70, 216) to either said purge tank (402) or to said clean water tank (220).

18. The appliance as in claim 1, further comprising at least one three-way valve (242) coupled between said filter (214), said clean water tank (220), and said purge tank (402), said three-way valve (242) for selectively allowing fluid to flow from said filter (214) to either said purge tank (402) or to said clean water tank (220).
